(19) United States
(12) Patent Application Publication
(10) Pub. No.: US 2015/0199780 A1
(43) Pub. Date: Jul. 16, 2015

(54) METHODS AND SYSTEMS FOR DIGITAL AGREEMENT ESTABLISHMENT, SIGNING, CENTRALIZED MANAGEMENT, AND A STOREFRONT USING HEAD MOUNTED DISPLAYS AND NETWORKS

(71) Applicant: Alex Beyk, Sunnyvale, CA (US)

(72) Inventor: Alex Beyk, Sunnyvale, CA (US)

(21) Appl. No.: 14/157,508

(22) Filed: Jan. 16, 2014

(51) Int. Cl. G06Q 50/18; G06Q 10/00; G06Q 30/00

(52) U.S. Cl. CPC G06Q 50/184; G06Q 30/00; G06Q 10/00

(57) ABSTRACT

The introduction of head mounted displays, heads up displays, and near eye displays in conjunction with special methods and systems can bridge the gap towards establishing paperless agreements in a convenient manner in near real time. The present invention relates to methods and systems to review, edit, sign, initial, date, and collaborate with one or multiple parties on agreements using head mounted displays (HMDs) in near real time. Furthermore, the invention relates to methods and systems for centralized management of agreements and a storefront to browse, sort, rate, purchase, and archive agreements and agreements templates via head mounted displays and cloud services.

### FIELD OF INVENTION

The present invention relates to methods and systems to review, edit, and sign digital agreements using head mounted displays in near real time. Furthermore, the invention relates to methods and systems for centralized management of digital agreements and a storefront to browse, sort, rate, purchase, and archive digital agreements via head mounted displays and networks.

### BACKGROUND OF INVENTION

Unless otherwise indicated herein, materials described in this application are not prior art to the claims in this application. Current day personal computing devices including laptops, smartphones, tablets and countless Internet enabled devices have become increasingly prevalent. However, most agreements including contracts continue to be printed on paper, read, initialed, dated, signed and archived on paper. The introduction of head mounted displays (HMD), heads up displays (HUD), and near eye displays (NED) in conjunction with special methods and systems can bridge the gap towards establishing paperless agreements in a convenient manner in near real time. HMDs may be used to review, edit, sign, initial, date, and collaborate with one or more parties on digital agreements. Network connected HMDs may access a centralized digital agreement management system and a storefront to browse, sort, rate, purchase, and archive digital agreements and digital agreements templates hosted via networks. With the help of custom back-end server software, HMD users can quickly be verified, agreements can take place in near real-time, reneging may be reduced, agreement expirations notifications may be automatic, agreements may be pre-selected for HMD users based on historical and other data, digital agreements may be conveniently auto-archived, and the cost of establishing and maintaining agreements may be significantly reduced.

### SUMMARY OF INVENTION

The features, methods and systems of the invention described herein may be practiced alone or in combination. Furthermore, the foregoing summary of features, methods, and systems are described as examples. They are only illustrative and are not intended to be limiting in any way. Users and legal entities partaking in an agreement may use one or more types of head mounted displays (HMD) which may provide computer generated graphics in the form of text and/or images. The use of text and/or images may be saved in files and may constitute a digital document such as a digital agreement or digital agreement template. HMDs may be used to review, edit, sign, initial, date, establish and collaborate with one or more parties on agreements in near real time. Network connected HMDs may access a centralized agreement management system and a storefront to browse, sort, rate, purchase, and archive digital agreements and digital agreements templates hosted via networks.

Note that the various features of the present invention described above may be practiced alone or in combination. These and other features of the present invention will be described in more detail below in the detailed description of the invention and in conjunction with the following figures.

### BRIEF DESCRIPTION OF DRAWINGS

In order that the present invention may be more clearly ascertained, some embodiments will now be described, by way of example, with reference to the accompanying drawings, in which:

FIGS. 1 through 13 illustrate several embodiments of head mounted displays in accordance with the present invention;

FIGS. 14 through 16 illustrate several embodiments of head mounted displays and how people may wear the head mounted display in accordance with the present invention;

FIG. 17 through 18 illustrate several embodiments of head mount displays connecting to networking options for head mounted displays in accordance with the present invention;

FIG. 19 illustrates several embodiments of voice commands to edit and manage digital agreements using a head mounted display in accordance with the present invention;

FIG. 20 illustrates several embodiments of finger movements on the head mounted display touch pad manipulating digital agreements including page movement, document scrolling movement and document field focus movement in accordance with the present invention;

FIG. 21 illustrates several embodiments of finger movements on the head mounted display buttons manipulating digital agreements including page movement, document scrolling movement and document field focus movement in accordance with the present invention;

FIG. 22 illustrates several embodiments of limb, hand and finger motion on a virtual sketchpad forming letters, text, dates, names, numbers, words, page movement, document scrolling movement, and document field focus movement for digital agreement manipulation in accordance with the present invention;

FIGS. 23A and 23B illustrate several embodiments of eye motion for digital agreement manipulation generating including page movement, document scrolling movement document field focus movement using a head mounted display systems in accordance with the present invention;

FIG. 24 illustrates several embodiments of head motion for digital agreement manipulation and generating page movement, document scrolling movement or document field focus movement using head mounted display systems in accordance with the present invention;

FIG. 25 illustrates the main built-in hardware modules in the head mounted display in accordance with the present invention;

FIG. 26 illustrates the main built-in input, output and orientation modules in the head mounted display in accordance with the present invention;

FIG. 27 illustrates the main built-in application modules in the head mounted display in accordance with the present invention;

FIG. 28 illustrates the main custom application modules in the head mounted display in accordance with the present invention;

FIG. 29 illustrates the main custom user facing web application modules hosted via cloud services in accordance with the present invention;

FIG. 30 illustrates the main custom back end web application modules hosted via cloud services in accordance with the present invention;

FIGS. 31A-H illustrate methods for head mounted display users to register for a digital agreements signing, establishment, centralized management system and a storefront in accordance with the present invention; and

FIGS. 32A-I illustrate methods for head mounted display users to use a digital agreements signing, establishment, centralized management system and a storefront in accordance with the present invention.

### DETAILED DESCRIPTION

The following detailed description describes features, functions, methods, and systems of the present invention with references to the accompanying figures. In the figures, similar symbols typically identify similar components. The illustrations in the figures, methods, and systems can be arranged, substituted, combined, separated, and designed in a variety of different configurations without departing from the spirit or scope of the subject matter presented herein. They are not meant to be limiting and aspects of the figures, methods, and systems can be arranged and combined in a wide variety of different configurations. In certain instances, well known processes and steps have not been described in detail in order to maintain focus on the invention.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to methods and systems for near real time establishment of agreements. Agreements include gentleman's agreements and legal agreements in the form of online agreements, agreement documents, agreement files and formal digital agreements will be referred to as digital agreements or digital agreement documents in the present invention. This invention relates to digital agreements signing, establishment, centralized management and a storefront using head mounted displays, networks, and cloud services. With the introduction of head mounted displays (HMDs), heads up displays (HUDs), near eye displays (NEDs), and eye displays (EDs) in conjunction with special methods and systems, these technologies may be used to manage digital agreements including the ability to review, edit, sign, initial, date, and collaborate with one or more parties on agreements. For a special class of documents and agreements such as wills and testaments, this technology may be used by reviewed, edited, signed, initialed, dated, established and archived for oneself

Network connected HMDs may access a centralized agreement management system and a storefront to browse, sort, rate, purchase, establish, and archive agreements and agreements templates hosted via networks and cloud services. The combined features, functions, methods, and systems may be leveraged by individual users and/or legal entities with head mounted displays.

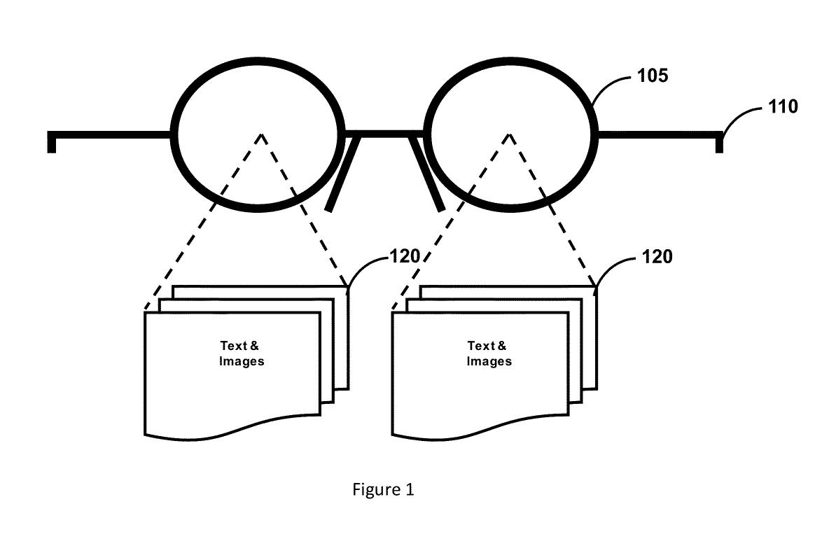

FIGS. 1 through 13 are examples of HMDs with a frame, optics, and electronics including a processor, memory, storage, networking, and other components. The examples show various HMDs with features to display, project, and reflect exemplary text and images as shown in exemplary projection 120. The exemplary HMDs come in different designs, shapes, sizes and with varying complexity which may be worn as a monocle, an eyeglass, a eyepiece, binoculars, eyeglasses, and goggles.

In FIG. 1, the exemplary HMD device 110 displays text and images in the exemplary projection 120 inside the circular shaped frame and glass elements 105 of the HMD.

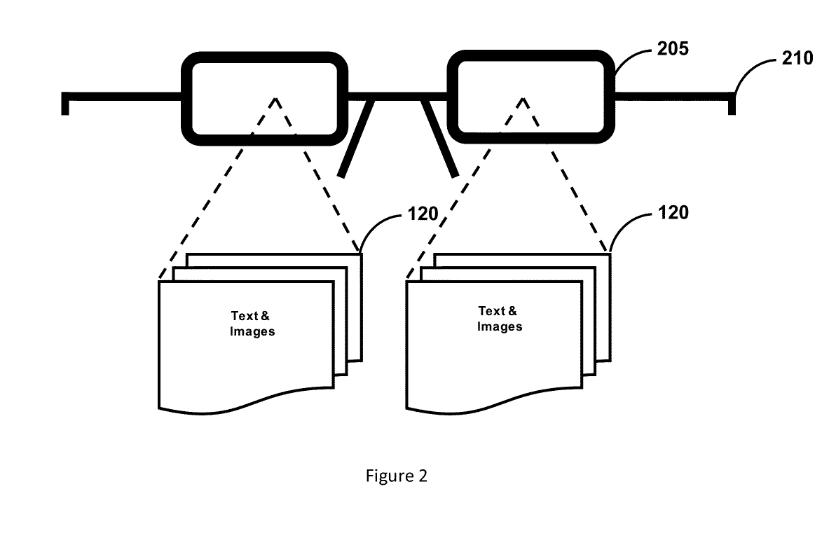

In FIG. 2, the exemplary HMD device 210 displays text and images in the exemplary projection 120 inside the rounded rectangular shaped frame and glass elements 205 of the HMD.

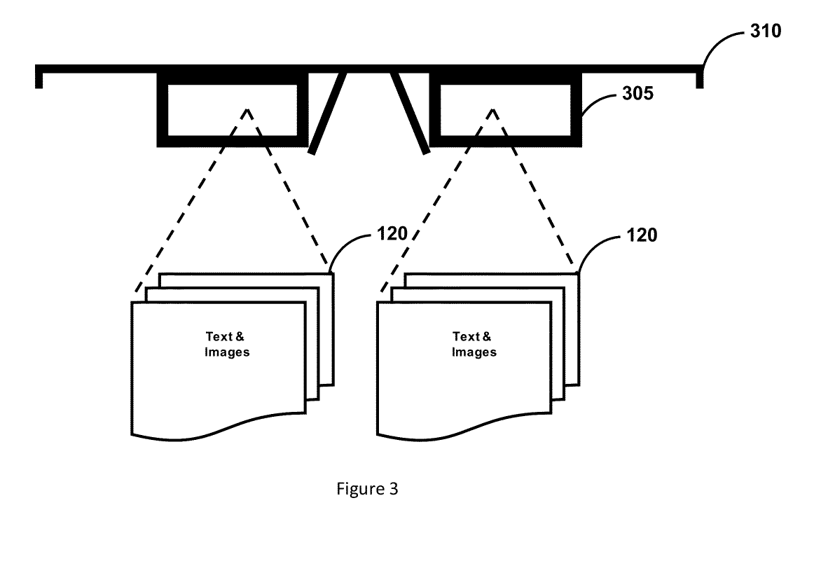

In FIG. 3, the exemplary HMD device 310 displays text and images in the exemplary projection 120 inside the rectangular shaped frame and glass elements 305 of the HMD.

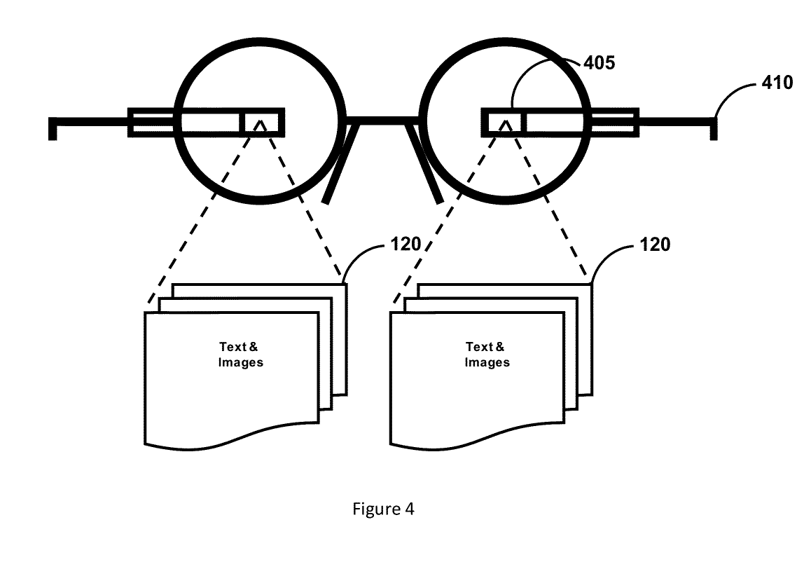

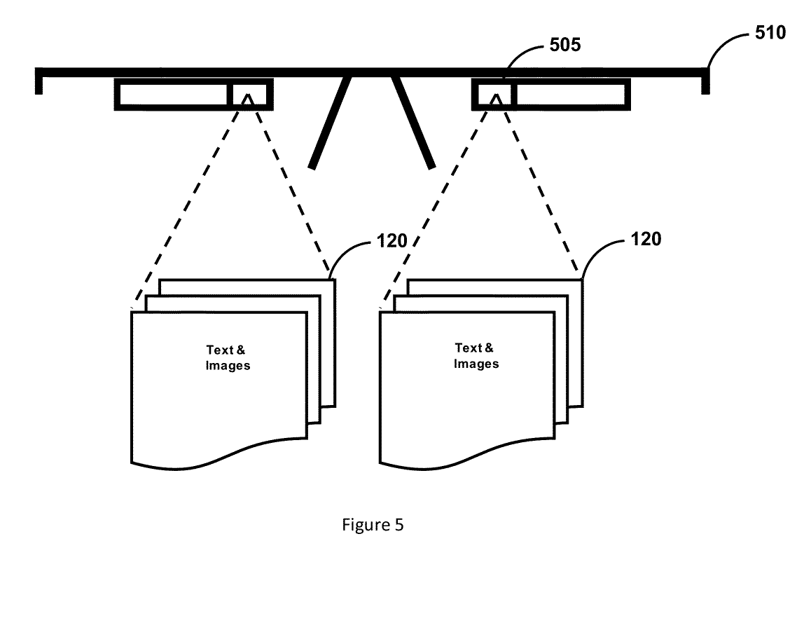

In FIG. 4, the exemplary HMD device 410 displays text and images in the exemplary projection 120 inside the rectangular shaped frame and glass elements 405 of the HMD. Furthermore, FIG. 4 illustrates HMD elements which are in front of a round shaped spectacle frame and glass.

In FIG. 5, the exemplary HMD device 510 displays text and images in the exemplary projection 120 inside the mini rectangular shaped frame and glass elements 505 of the HMD.

Furthermore, FIG. 5 illustrates HMD elements including a processor, memory, networking, and other components in a separate housing next to the glass display.

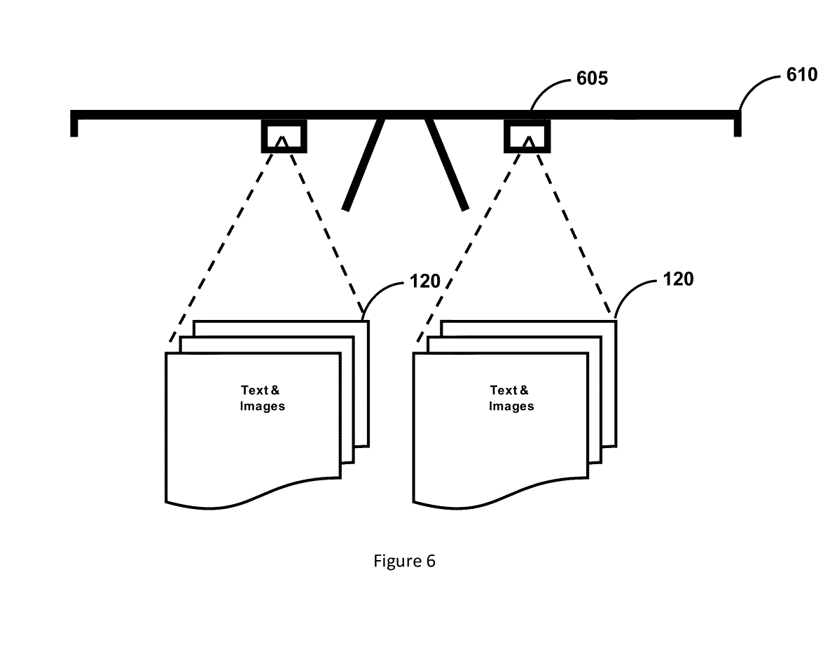

In FIG. 6, the exemplary HMD device 610 displays text and images in the exemplary projection 120 inside the mini rectangular shaped frame and glass elements 605 of the HMD.

Furthermore, FIG. 6 illustrates HMD elements including a processor, memory, networking, and other components built inherently into the HMD frame.

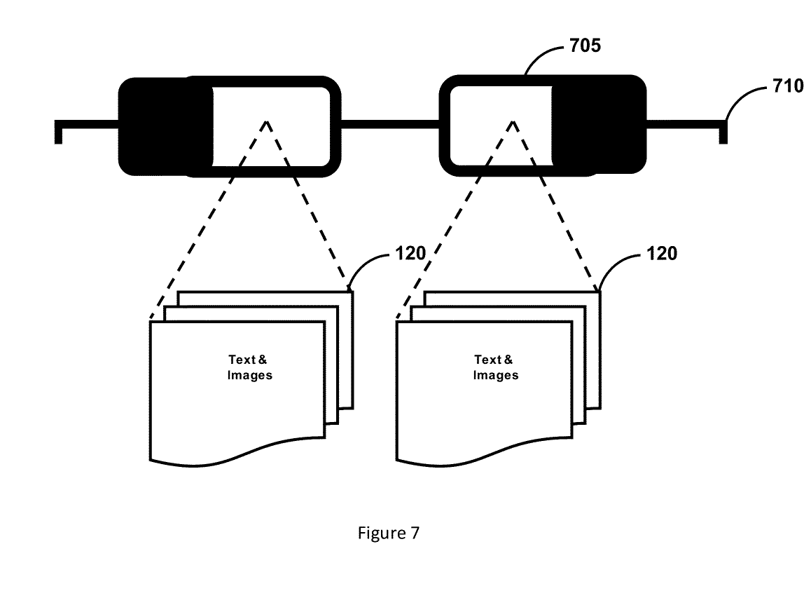

In FIG. 7, the exemplary HMD device 710 displays text and images in the exemplary projection 120 inside the large rounded rectangular shaped frame and glass elements 705 of the HMD. Furthermore, FIG. 7 illustrates HMD elements including a processor, memory, networking and other components built into a large square housing next to the glass display.

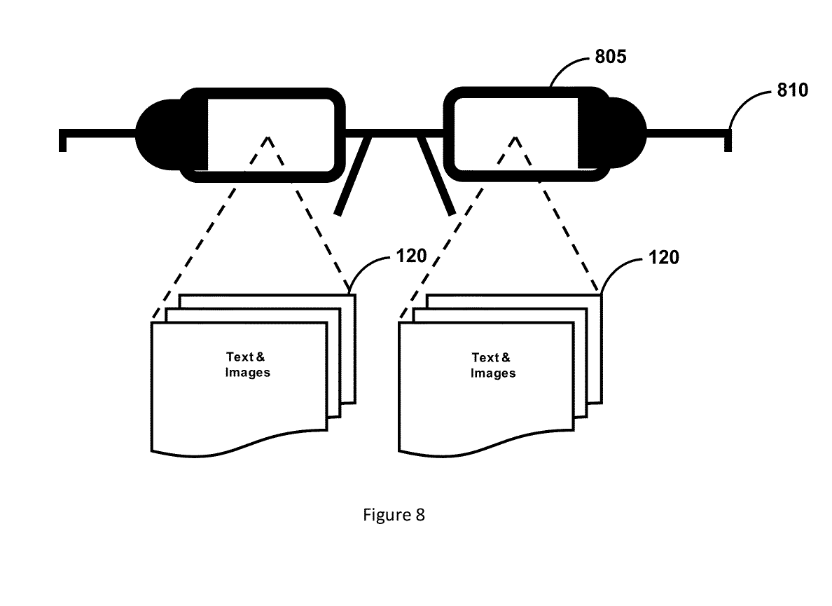

In FIG. 8, the exemplary HMD device 810 displays text and images in the exemplary projection 120 inside the rounded rectangular shaped frame and glass elements 805 of the HMD. Furthermore, FIG. 8 illustrates HMD elements including a processor, memory, networking and other components built into a mini rounded housing next to the glass display.

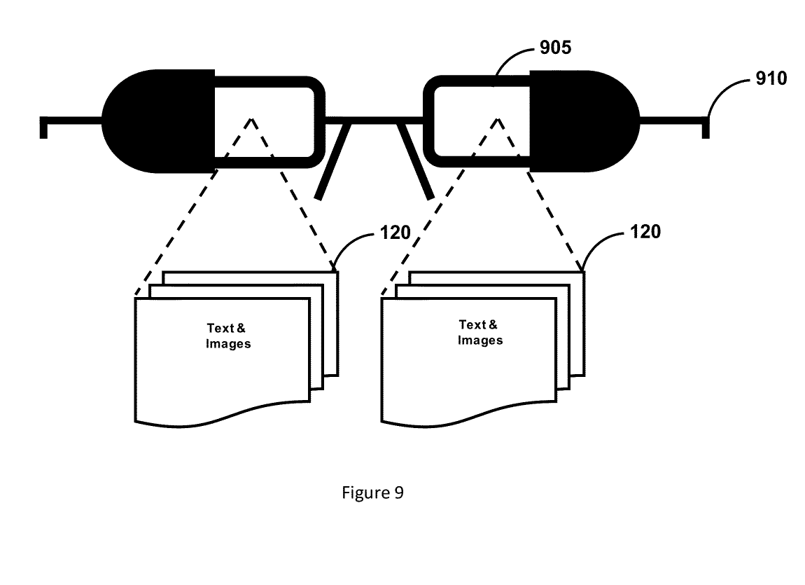

In FIG. 9, the exemplary HMD device 910 displays text and images in the exemplary projection 120 inside the rounded rectangular shaped frame and glass elements 905 of the HMD. Furthermore, FIG. 9 illustrates HMD elements including a processor, memory, networking and other components built into a large rounded housing next to the glass display.

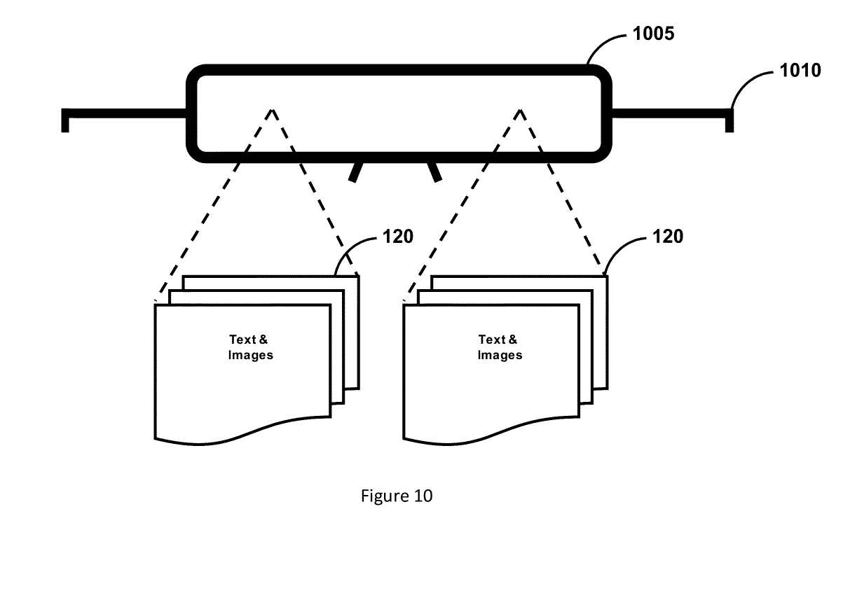

In FIG. 10, the exemplary HMD device 1010 displays text and images in the exemplary projection 120 inside the long rounded rectangular shaped frame and glass elements 1005 of the HMD. The large glass includes a polarization system or the glass may include an auto-dim software method. Furthermore, FIG. 10 illustrates HMD elements including a processor, memory, networking and other components built inherently into the long rounded rectangular housing.

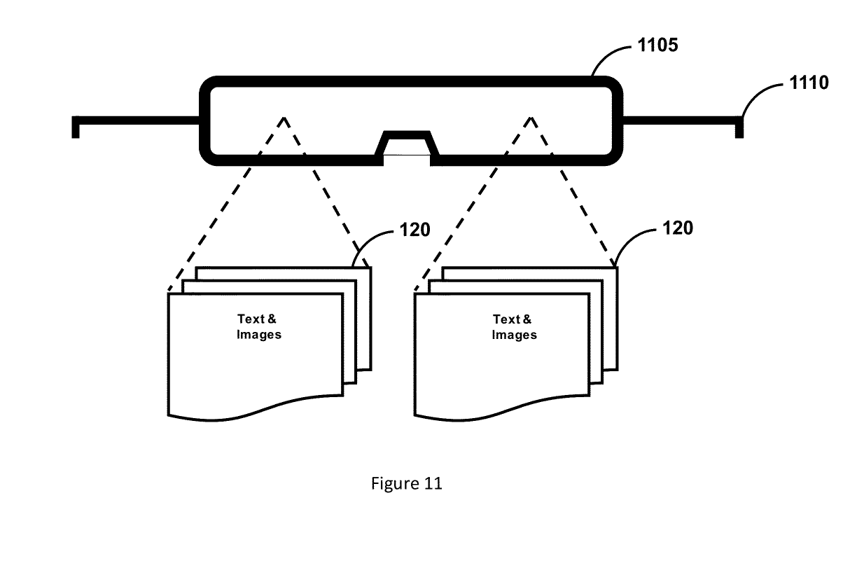

In FIG. 11, the exemplary HMD device 1110 displays text and images in the exemplary projection 120 inside the long rounded rectangular shaped frame and glass elements 1105 of the HMD. The large glass includes a polarization system or the glass may include an auto-dim software method. Furthermore, FIG. 11 illustrates HMD elements including a processor, memory, networking and other components built inherently as a part of the long rounded rectangular housing.

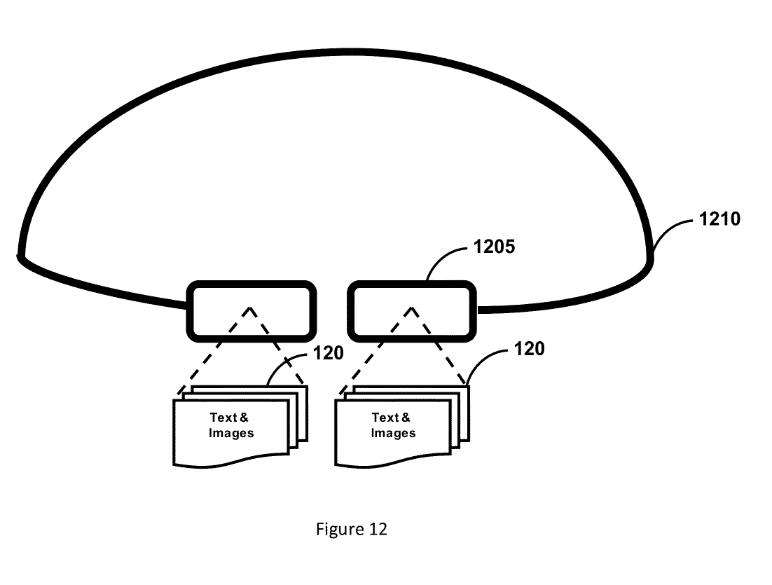

In FIG. 12, the exemplary HMD device 1210 displays text and images in the exemplary projection 120 inside the rounded rectangular shaped frame and glass elements 1205 of the HMD. FIG. 12 illustrates HMD elements including a processor, memory, networking, and other components built inherently into the HMD frame which goes around the head. This unique head mounted frame may be worn inside or outside of hats, helmets, or simply for comfort.

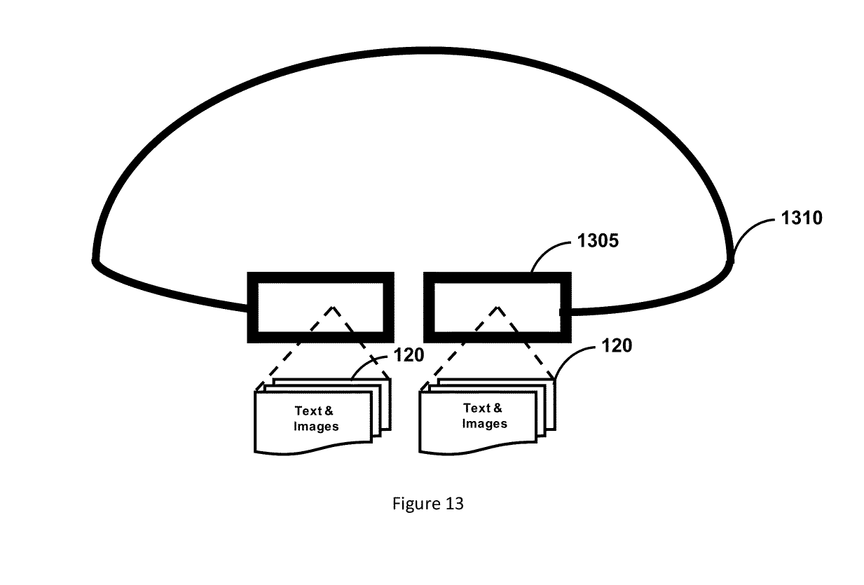

In FIG. 13, the exemplary HMD device 1310 displays text and images in the exemplary projection 120 inside the rectangular shaped frame and glass elements 1305 of the HMD. FIG. 13 illustrates HMD elements including a processor, memory, networking, and other components built inherently into the HMD frame which goes around the head. This unique head mounted frame may be worn inside or outside of hats, helmets, or simply for comfort.

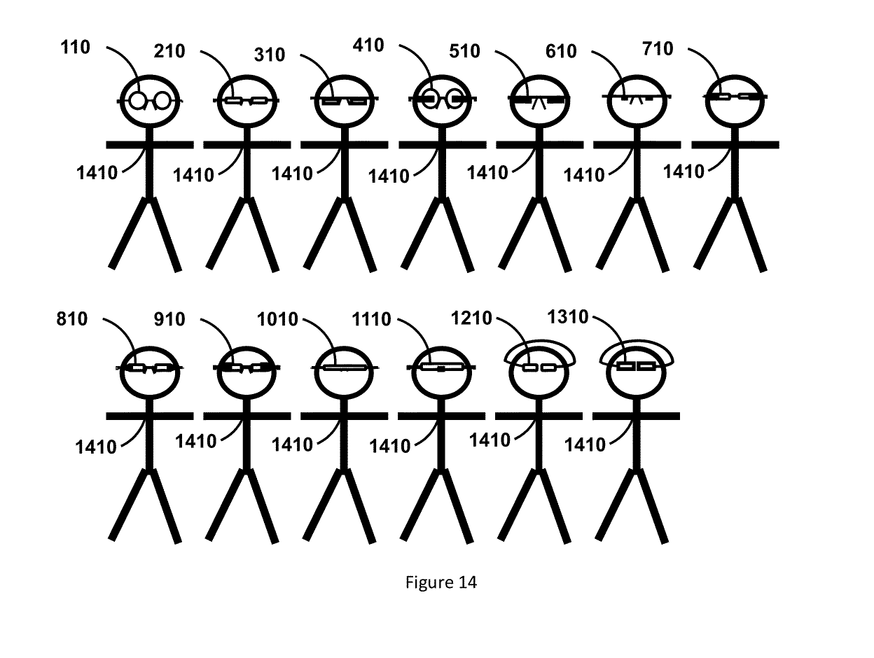

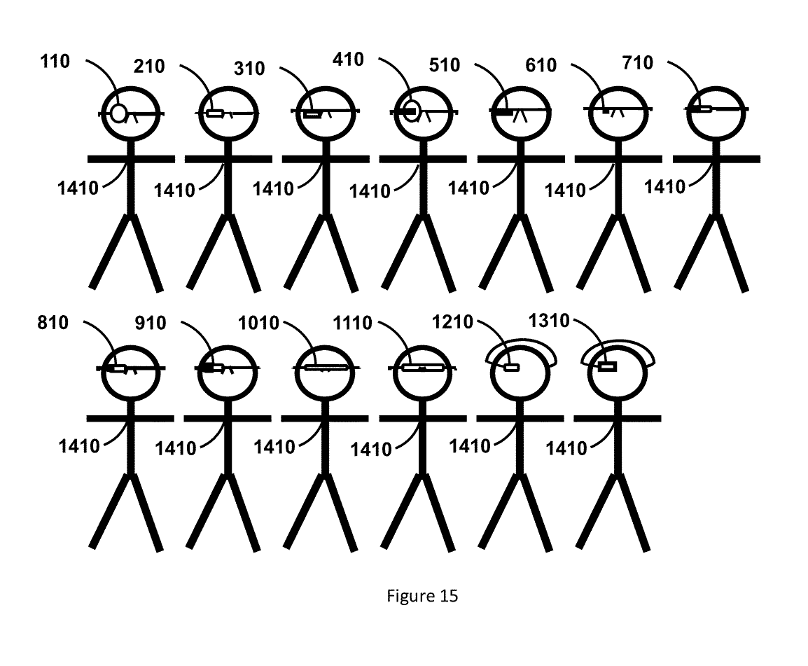

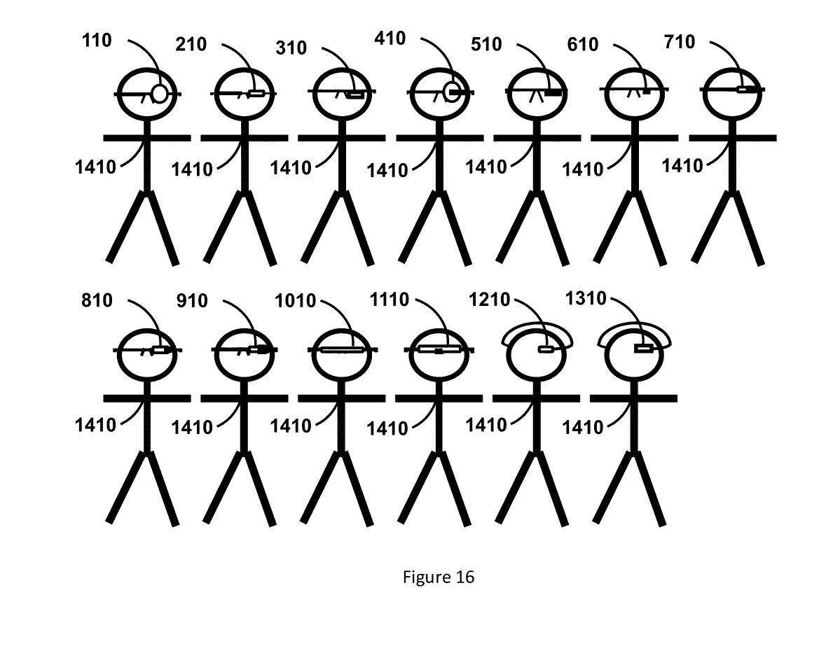

FIG. 14 illustrates examples of how a person 1410 may wear HMD devices 110, 210, 310, 410, 510, 610, 710, 810, 910, 1010, 1110, 1210, and 1310. HMDs may be operated by a person 1410, mounted in stereo on the head with HMD display capabilities over both the left and right eye as illustrated in FIG. 14, mounted on the left side of the head over the left eye as illustrated in FIG. 15, and mounted on the right side of the head over the right eye as illustrated in FIG. 16.

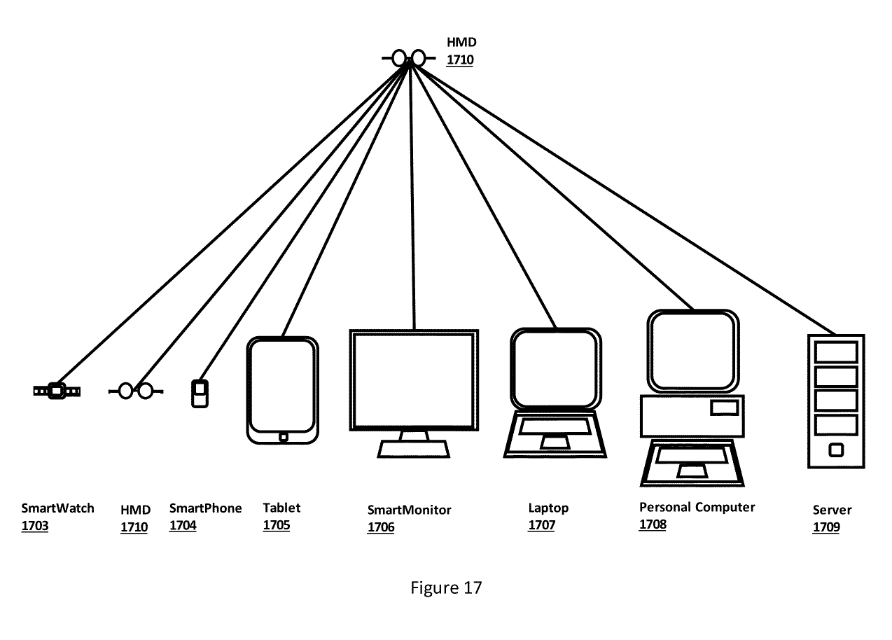

FIG. 17 illustrates the ability to use HMDs to connect to external compute devices, networks, storage devices and smart devices. Examples include; Intranet connections via Bluetooth, WIFI, LAN, WAN and Radio connections, Internet connections via Bluetooth, WIFI, LAN, WAN and Radio connections, smart watch 1703, smartphone 1704, smart tablet or tablet 1705, smart monitor or all-in-one computer 1706, laptop 1707, personal computer 1708, server 1709, and a smart glass or HMD 1710. HMDs connected to these external devices may leverage additional resources for computing, storage, user identification, and increased network throughput providing expanded features for accessing, establishing, sharing and managing formal digital agreements, contracts, deeds and other digital online documents.

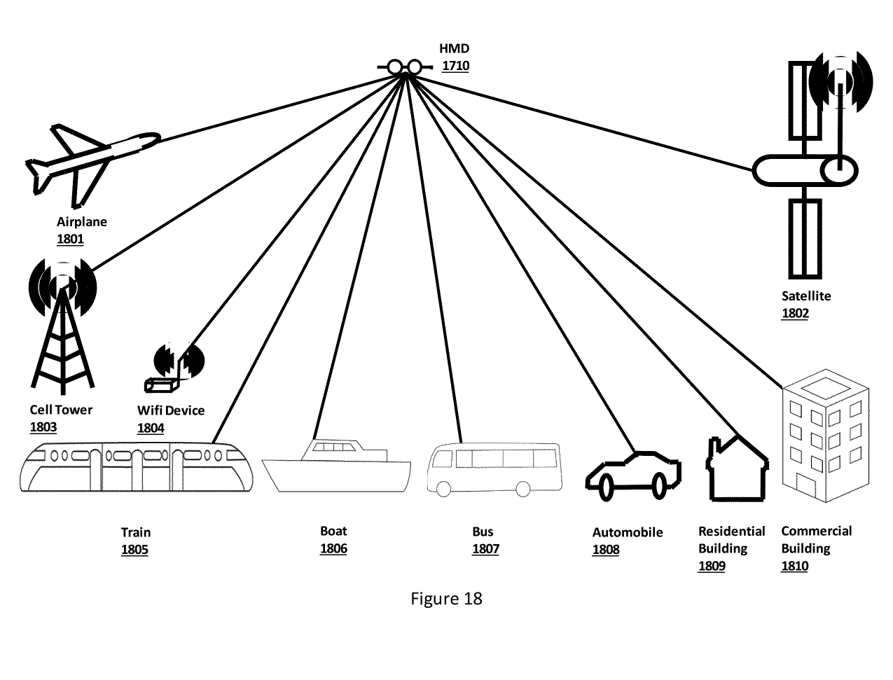

FIG. 18 illustrates the ability to use HMDs to connect with network access points and networking equipment in buildings and transportation systems. Examples include; an airplane 1801, satellite 1802, cell tower 1803, WIFI 1804, train 1805, boat 1806, bus 1807, automobile 1808, residential building 1809, and a commercial building 1810. HMDs connected to these external devices may leverage additional resources for computing, storage, user identification, and increased network throughput providing expanded features for accessing, establishing, sharing, and managing formal digital agreements, contracts, deeds and other digital online documents.

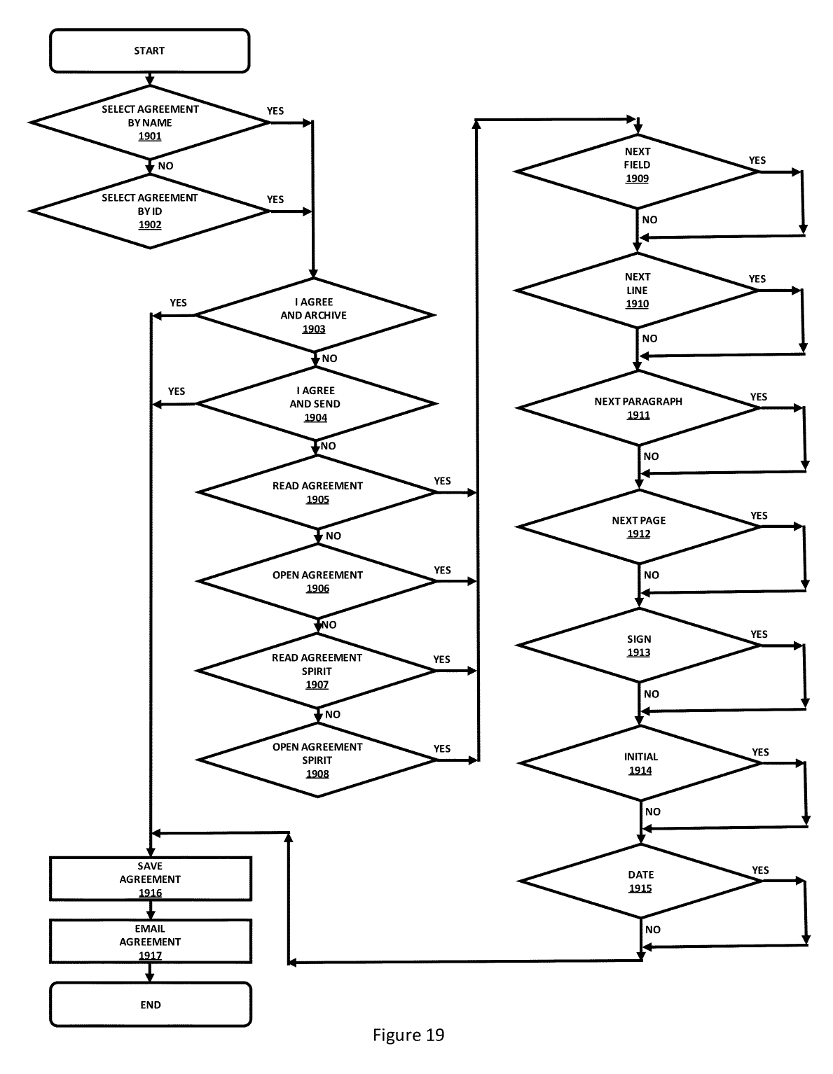

FIGS. 19 to 24 provide example methods for manipulating formal digital agreements via HMD devices by HMD users. The example methods describe processing physiological user input for the purpose of managing or updating a formal digital agreement. Physiological user input involves vocalized sound through vocal cords, or movement from an arm, eye, eyelids, hand, head, and a finger. The above-mentioned physiological user input may be detected by HMD device components including buttons, cameras, a gyroscope, a motion sensor, a scanner, and a touch pad.

FIG. 19 illustrates an example of how HMDs may be used to establish and sign agreements using verbal commands and voice prints. Through a combination of inherent HMD hardware, software, and custom software, components such as the microphone, processor, speaker, and storage memory, they allow the HMD user to select the digital agreement by speaking the digital agreement or digital agreement template name or id. Once the digital agreement or digital agreement template is selected, the HMD user may decide amongst several methods to review, read, listen to, establish and sign the digital agreement document. In the following examples, the HMD user may speak so the HMD device microphone may receive commands to manipulate formal digital agreements. Additionally, in the following examples, the HMD user may use the word essence and the word spirit interchangeably to command the HMD device to provide a summary of the formal digital agreement. The HMD user may select the digital agreement by speaking the digital agreement name in step 1901 and by selecting the digital agreement by id, by speaking the digital agreement id in step 1902. By speaking “I agree and archive” as in step 1903, the system automatically verifies the HMD user voice print, signs, initials, and dates any and all necessary fields in the digital agreement, and archives the digital agreement. By speaking “I agree and send” as in step 1904, the system automatically verifies the HMD user voice print, signs, initials, and dates any and all necessary fields in the digital agreement, and provides methods to send the digital agreement to oneself, or one or more parties. By speaking “Read agreement” as in step 1905, the system starts reading the full digital agreement for the HMD user to listen to the digital agreement contents. By speaking “Open agreement” as in step 1906, the system opens the full digital agreement for the HMD user to read or review via the HMD, HUD, NED, or ED. By speaking “Read agreement spirit” as in step 1907, the system starts reading a summary of the important elements of the digital agreement for the HMD user to listen to. By speaking “Open agreement spirit” as in step 1908, the system opens a summary of the important elements of the digital agreement for the HMD user to read via the HMD, HUD, NED, or ED. The “agreement spirit” is the essence or summary of a digital agreement document. The “agreement spirit” may be used to provide a shorter preview and review of the digital agreement with all the necessary significant digital agreement areas for the user. In short, a time saver compared to previewing and reviewing the entire digital agreement. By speaking “Next Field” as in step 1909, the system goes (or moves the cursor) to the next input field in the digital agreement document. By speaking “Next Line” as in step 1910, the system goes (or moves the cursor) to the next line or sentence in the digital agreement document. By speaking “Next Paragraph” as in step 1911, the system goes (or moves the cursor) to the next paragraph or section in the digital agreement document. By speaking “Next Page” as in step 1912, the system goes (or moves the cursor) to the next page or section in the agreement document. By speaking “Sign” as in step 1913, the system automatically verifies the HMD user, enters the HMD users autograph or digital signature in the digital agreement document. This assumes the HMD user's autograph or digital signature was captured, recorded, and verified during the registration process as is described in another section of the present invention. By speaking “Initial” as in step 1914, the system automatically enters the user's initials in the digital agreement document. This assumes the user's initials may have been captured, recorded, and verified during the registration process as is described in another section in the present invention. By speaking “Date” as in step 1915, the system automatically enters the local date and time in the digital agreement document. By speaking “Save Agreement” as in step 1916, the system automatically saves the digital agreement locally on the HMD and if both network connectivity is available and the HMD user has selected to archive digital agreement documents remotely on a network or in the cloud, a document archive is saved via the Intranet or Internet network, often including Cloud Services aka Web Services. By speaking “Email Agreement” as in step 1917, the system automatically opens an email composition screen to enter or speak the one or more email recipients and attaches the digital agreement document. Other features not easily illustrated, but better described include the ability to speak one's name or a keyword so the HMD device may be used to process the users voice print data. The voice pattern data may serve the purpose of a unique identifier for authentication, verification, to provide a unique voice autograph, a command, and a verifiable signature.

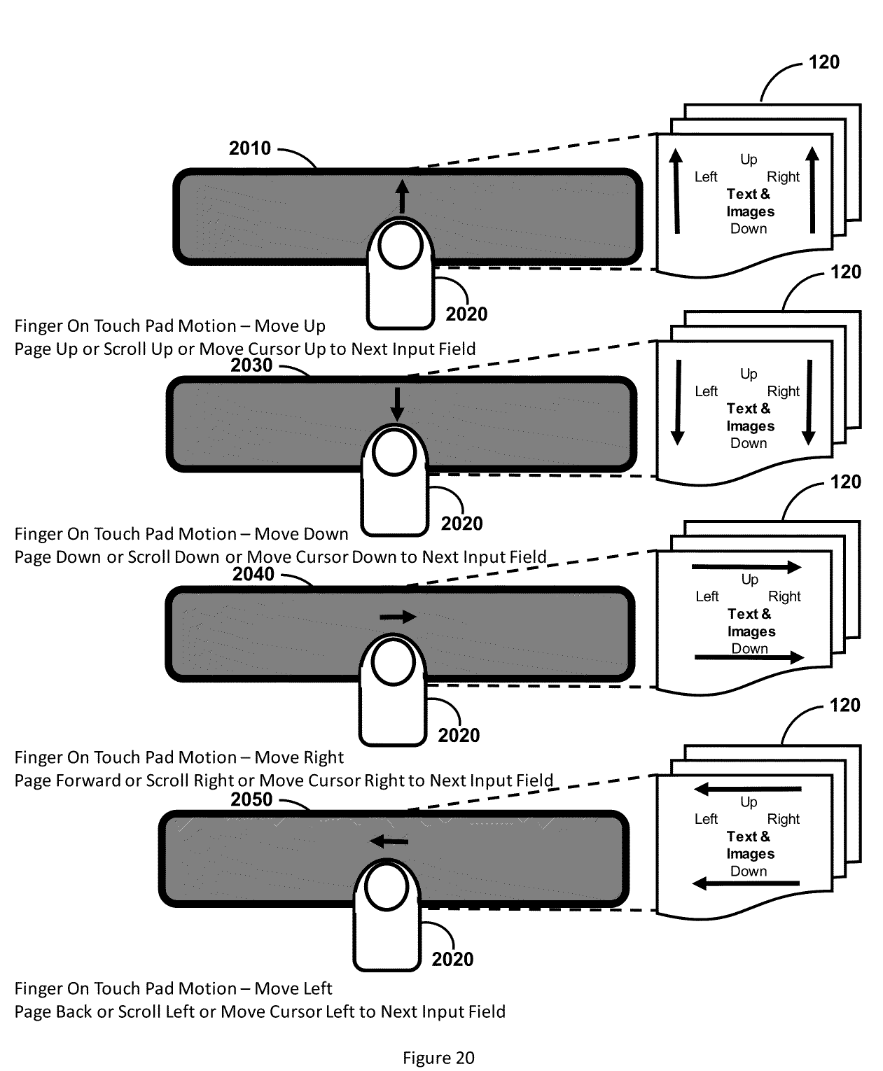

FIG. 20 illustrates a touch pad which may be mounted on the HMD device to provide digital agreement document manipulation and navigation features and functions to be processed by the HMD processor for command execution according to HMD user finger motion and finger selection on the touch pad 2010 of the HMD. Examples of how finger motions on the touch pad may be interpreted as commands by the HMD in the present invention are described below. By moving the HMD users finger 2020 up on the touch pad 2010 of the HMD device, the system will move the page up, scroll up or move the cursor up to the next field depending on the context and what is currently displayed on the HMD in the exemplary projection 120. By moving the HMD users finger 2020 down in on the touch pad 2030 of the HMD device, the system will move the page down, scroll down or move the cursor down to the next field depending on the context and what is currently displayed on the HMD in the exemplary projection 120. By moving the HMD users finger 2020 right on the touch pad 2040 of the HMD device, the system will move the page right, scroll right or move the cursor right to the next field depending on the context and what is currently displayed on the HMD in the exemplary projection 120. By moving the HMD users finger 2020 left on the touch pad 2050 of the HMD device, the system will move the page left, scroll left or move the cursor left to the next field depending on the context and what is currently displayed on the HMD device in the exemplary projection 120. Other features not easily illustrated, but better described include the ability to use the HMD users finger to write on the touch pad for the purpose of providing a unique identifier for authentication, in the form of an autograph, command, and digital signature. In addition, double tapping the touch pad with a finger may provide the ability to make a new HMD user action or selection, or confirm an existing HMD user action or selection.

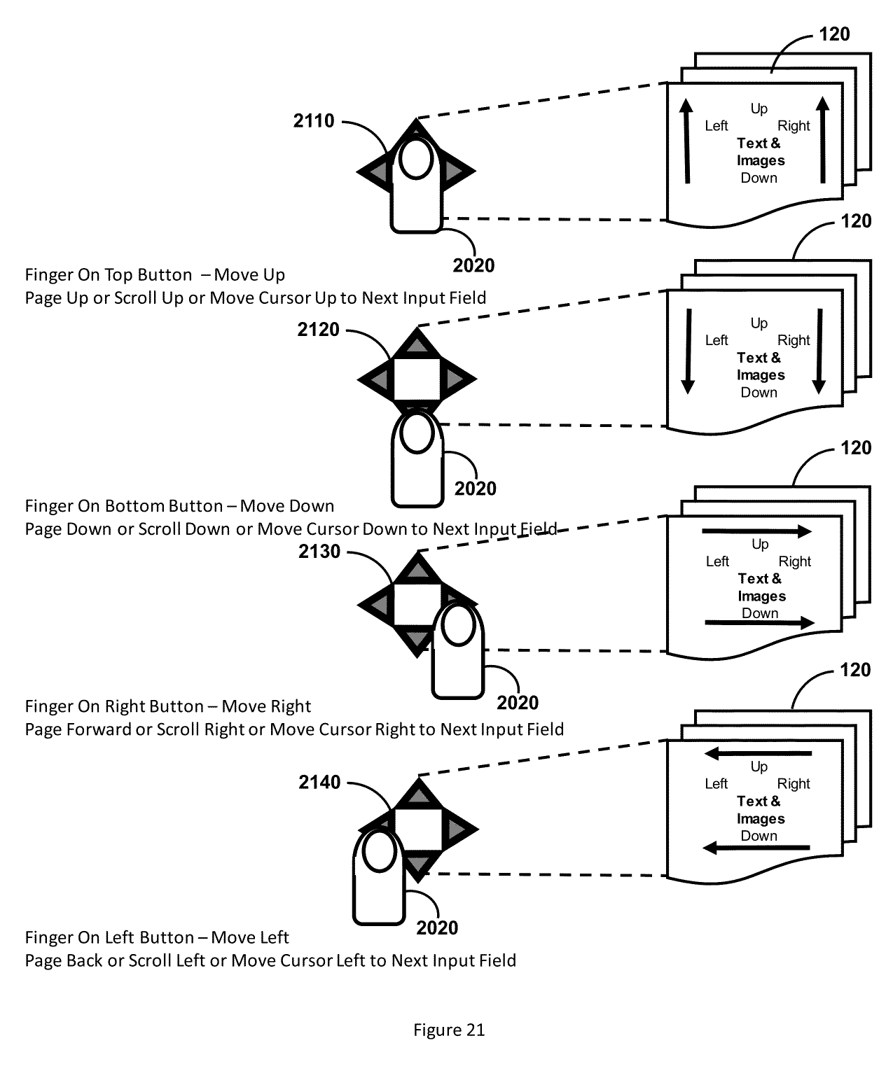

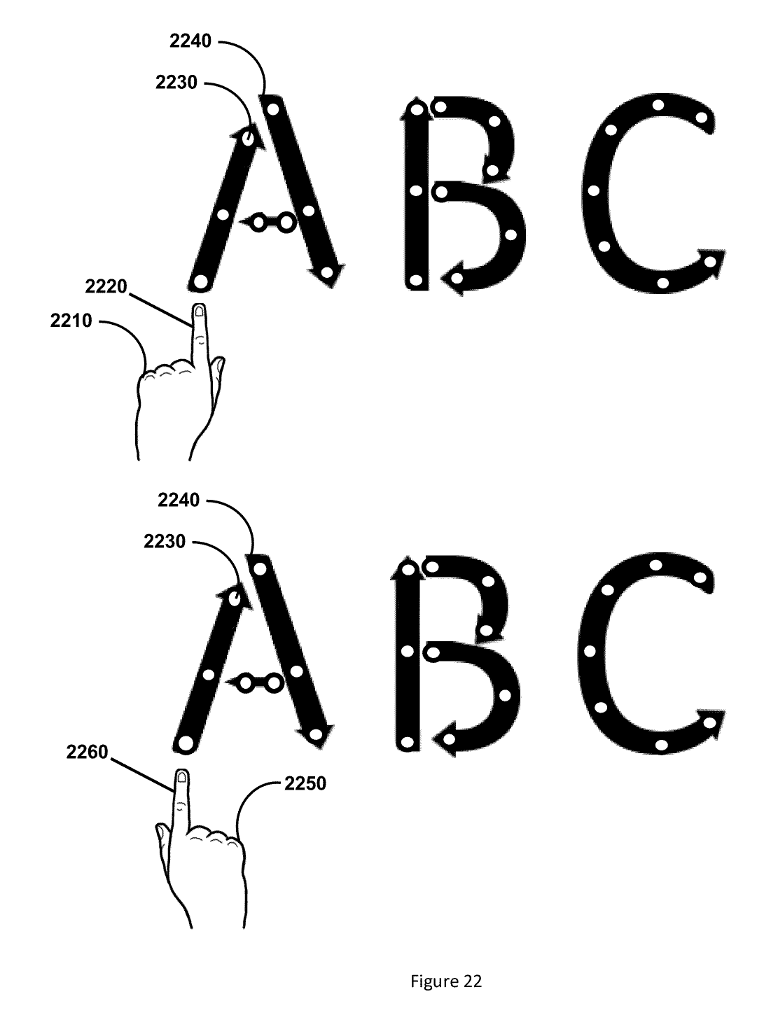

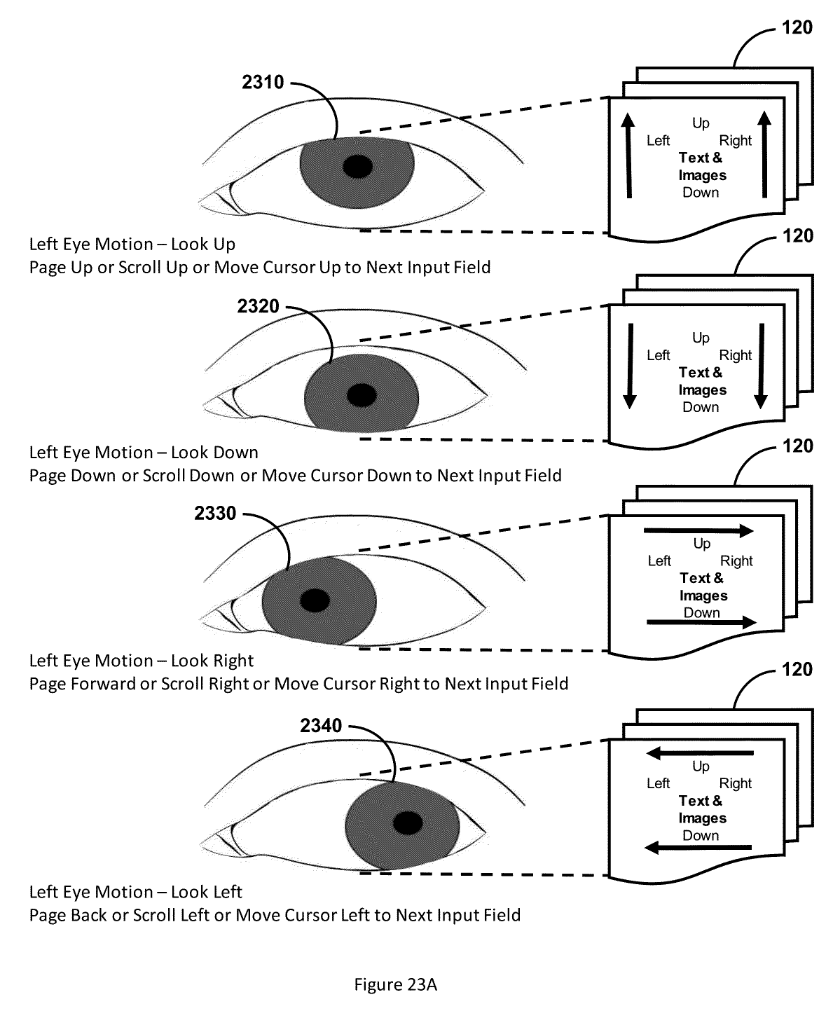

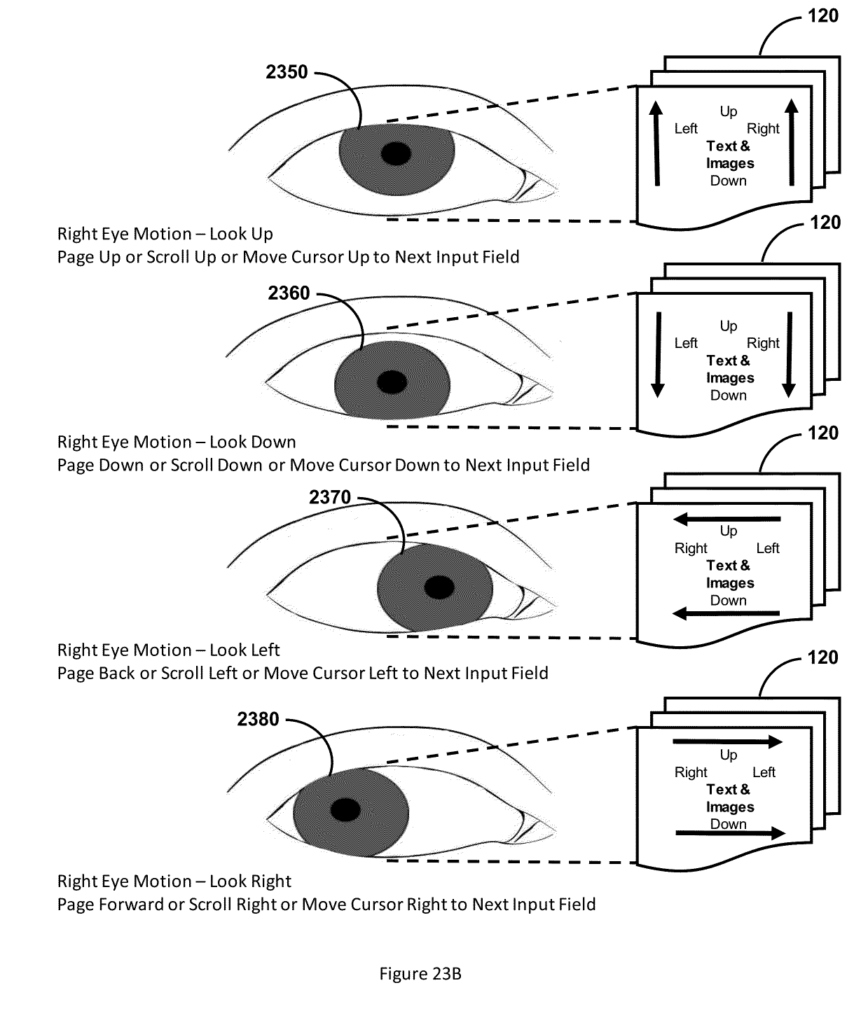

FIG. 21 illustrates buttons which may be mounted on the HMD device to provide digital agreement document manipulation and navigation features and functions to be processed by the HMD processor for command execution according to HMD user finger selection of the buttons. Examples of how HMD user finger selection of the buttons may be interpreted as commands by the HMD in the present invention are described below. By moving the HMD user's finger 2020 to press the HMD device top button 2110, the system will move the page up, scroll up or move the cursor up to the next field depending on the context and what is currently displayed on the HMD in the exemplary projection 120. By moving the HMD user's finger 2020 to press the HMD device bottom button 2120, the system will move the page down, scroll down or move the cursor down to the next field depending on the context and what is currently displayed on the HMD in the exemplary projection 120. By moving the HMD user's finger 2020 to press the HMD device right button 2130, the system will move the page right, scroll right or move the cursor right to the next field depending on the context and what is currently displayed on the HMD in the exemplary projection 120. By moving the HMD user's finger in FIG. 2020 to press the HMD device left button 2140, the system will move the page left, scroll left or move the cursor left to the next field depending on the context and what is currently displayed on the HMD in the exemplary projection 120.

FIG. 22 illustrates HMD user left hand motion 2210 and right hand motion 2250, left finger motion 2220, and right finger motion 2260. The examples of HMD user hands and fingers serve to show a HMD user providing a virtual pen in the form of a physical arm, a hand, a finger, a finger nail, a finger pinch, a finger ring, a finger sign, a physical writing utensil, and a stylus. The background, which may be a drawing surface, a sketch pad, a touch pad, a writing surface, some space in the air in front of the HMD device, white space in front of the HMD device, or a contrasting background in front of the HMD device and HMD user, may serve as the virtual sketchpad for the hand 2210 and 2250, the finger 2220 and 2260, or another pointing object to draw on. In the event a writing utensil such as a pencil or paper and physical sketchpad is used, a physical sketchpad may consist of a white board or piece of paper to draw or write on. As the user draws or writes, the camera on the head mounted display and software to record data on the display may be used to record data as in example steps 2230 and 2240. The data may be used by the HMD device to create and compare a data recording of the HMD user's digital autograph, digital countersignature, identifier, inscription, insignia, initials, mark, sign, digital signature, symbol, alphabet characters, numeric characters, punctuation characters, accented characters, and pictographic characters. The data recording may be further used for authentication and verification. Once authenticated or not, a software function on the processor of the HMD device may grant or deny the HMD user permission to execute an application. In addition, the biometric authentication data recording of the HMD user may be used by the HMD device to compare the cadence and images of the newly generated recorded data against previously generated recorded data belonging to the HMD user. The comparative verification of the HMD user recorded data is for the purpose of authentication and verification before the HMD user manages and manipulates digital agreements providing agreement, approval, authorization, certification, consent, endorsement, notarization, ratification, sanction, support, and a testimonial of a digital agreement document. The digital agreement document may include at least one of a standard agreement, non-standard agreement, bill of sale, bond, certificate, contract, covenant, deal, deed, license, notice, pact, pass, permit, term, ticket, and a will. Apart from providing digital signature information, the left or right hand and any finger may be used to provide biometric authentication data essentially allowing the HMD device to play a part in authenticating the HMD user. The biometric authentication data may be provided via a finger print, palm print or hand geometry.

FIGS. 23A and 23B illustrates one of a HMD users eye, iris or retina movement which may be detected by a camera or a scanner mounted on the HMD device to provide digital agreement document manipulation and navigation features and functions to be processed by the HMD device processor for command execution. Examples of how the HMD users left eye, iris or retina movement may be interpreted as commands by the HMD device in the present invention are described below. By moving the HMD users left eye, iris or retina of the eye 2310 up, the system will move the page up, scroll up or move the cursor up to the next field depending on the context and what is currently displayed on the HMD in the exemplary projection 120. By moving the HMD users left eye, iris or retina of the eye 2320 down, the system will move the page down, scroll down or move the cursor down to the next field depending on the context and what is currently displayed on the HMD in the exemplary projection 120. By moving the HMD users left eye, iris or retina of the eye 2330 right, the system will move the page right, scroll right or move the cursor right to the next field depending on the context and what is currently displayed on the HMD in the exemplary projection 120. By moving the HMD users left eye, iris or retina of the eye 2340 left, the system will move the page left, scroll left or move the cursor left to the next field depending on the context and what is currently displayed on the HMD in the exemplary projection 120. Examples of how right eye, iris and retina movement may be interpreted as commands by the HMD in the present invention are described below. By moving the HMD users right eye, iris or retina of the eye 2350 up, the system will move the page up, scroll up or move the cursor up to the next field depending on the context and what is currently displayed on the HMD in the exemplary projection 120. By moving the HMD users right eye, iris or retina of the eye 2360 down, the system will move the page down, scroll down or move the cursor down to the next field depending on the context and what is currently displayed on the HMD in the exemplary projection 120. By moving the HMD users right eye, iris or retina of the eye 2370 right, the system will move the page right, scroll right or move the cursor right to the next field depending on the context and what is currently displayed on the HMD in the exemplary projection 120. By moving the HMD users right eye, iris or retina of the eye 2380 left, the system will move the page left, scroll left or move the cursor left to the next field depending on the context and what is currently displayed on the HMD in the exemplary projection 120. Other features not easily illustrated, but better described include the ability to use one's eye lids to wink for the purpose of providing a command. A HMD users double eye lid wink within a few seconds or in succession, may provide the ability to make a new selection or confirm an existing user action or selection. For example, a HMD user double wink may mean “I agree”, “I authorize”, “Sign it” in the context of a digital agreement document. A HMD users triple eye lid wink within a few seconds or in succession, may provide the ability to make a new selection or confirm an existing user action or selection. For example, a HMD user triple wink may mean “I agree”, “I authorize”, “Sign it” in the context of a digital agreement document. Apart from digital agreement document management and manipulation, the eye scan, iris scan, and retina scan may be used to provide biometric authentication data essentially allowing the HMD device to play a part in authenticating the HMD user.

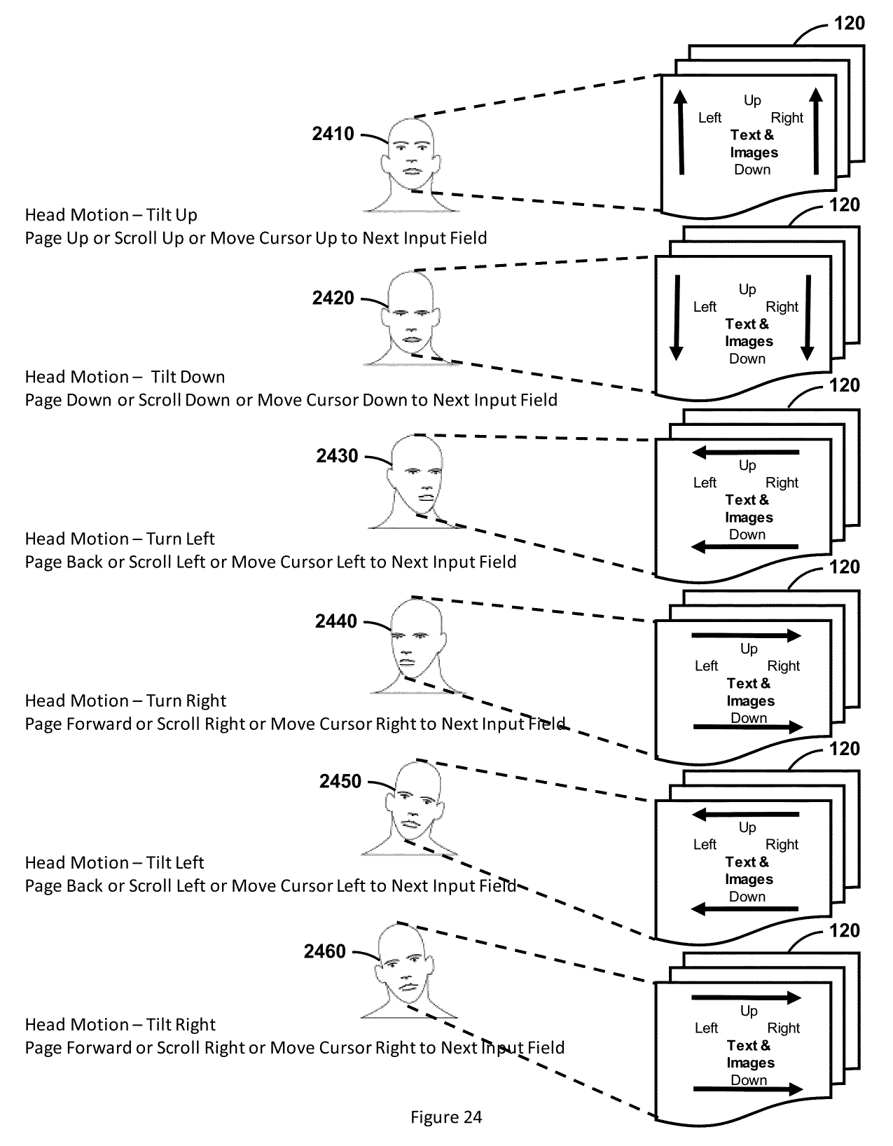

FIG. 24 illustrates head movement which may be detected by a combination of one or more components mounted on the HMD device including the gyroscope, motion sensor, GPS, and orientation sensor to provide digital agreement document manipulation and navigation features and functions to be processed by the HMD processor for command execution. Examples of how head motion or movement may be interpreted as commands by the HMD device in the present invention are described below. By moving or tilting the HMD users head 2410 up, the system will move the page up, scroll up or move the cursor up to the next field depending on the context and what is currently displayed on the HMD in the exemplary projection 120. By moving or tilting the HMD users head 2420 down, the system will move the page down, scroll down or move the cursor down to the next field depending on the context and what is currently displayed on the HMD in the exemplary projection 120. By moving or turning the HMD users head 2430 left, the system will move the page left, scroll left or move the cursor left to the next field depending on the context and what is currently displayed on the HMD in the exemplary projection 120. By moving or turning the HMD users head 2440 right, the system will move the page right, scroll right or move the cursor right to the next field depending on the context and what is currently displayed on the HMD in the exemplary projection 120. By moving or tilting the HMD users head 2450 left, the system will move the page left, scroll left or move the cursor left to the next field depending on the context and what is currently displayed on the HMD in the exemplary projection 120. By moving or tilting the HMD users head 2460 right, the system will move the page right, scroll right or move the cursor right to the next field depending on the context and what is currently displayed on the HMD in the exemplary projection 120.

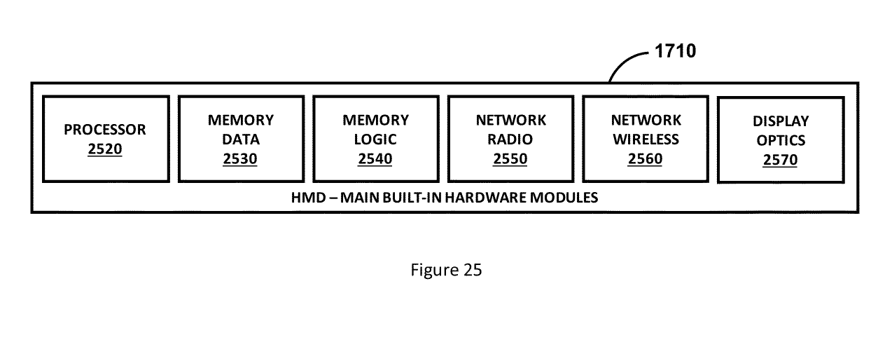

FIG. 25 illustrates the main built-in hardware modules or components in HMD 1710 including a processor 2520 for program execution, memory 2530 for data storage, memory 2540 for application loading and execution, network radio 2550 for communications, network wireless 2560 for communications, and display optics 2570 to display, project and reflect text and images. These modules will be leveraged by the present invention allowing users to view, edit, sign, manage and establish agreements, contracts, deeds and other electronic documents.

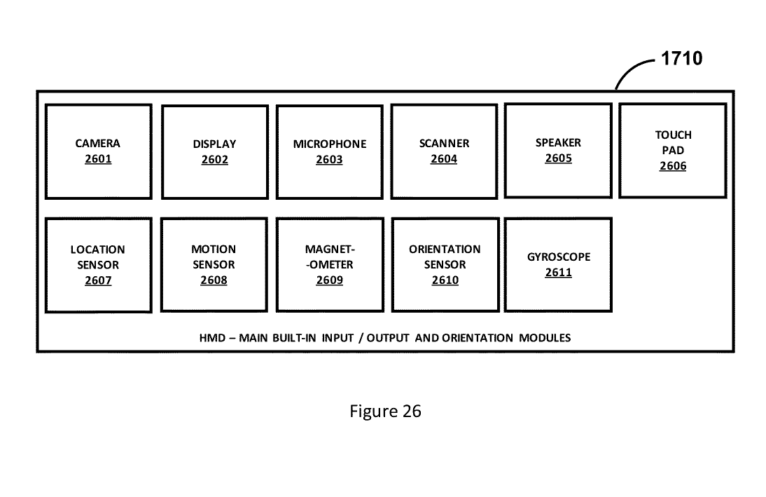

FIG. 26 illustrates the main input, output and orientation modules or components inherent in HMD 1710 including a camera 2601, display 2602, microphone 2603, scanner 2604, speaker 2605, touch pad 2606, location sensor 2607, motion sensor 2608, magnetometer 2609, orientation sensor 2610, and a gyroscope 2611. These modules will be leveraged by the present invention allowing users to view, edit, sign, manage and establish agreements, contracts, deeds and other electronic documents.

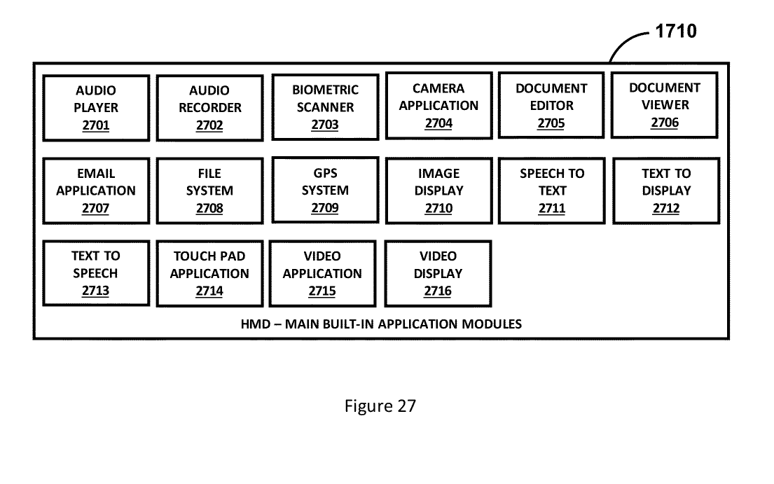

FIG. 27 illustrates the main built-in application modules or components provided by HMD 1710 including an audio player 2701, audio recorder 2702, biometric scanner 2703, camera application 2704, document editor 2705, document viewer 2706, email application 2707, file system 2708, GPS system 2709, image display 2710, speech to text 2711, text to display 2712, text to speech 2713, touch pad application 2714, video application 2715, and video display 2716. These modules will be leveraged by the present invention allowing users to view, edit, sign, manage and establish agreements, contracts, deeds and other electronic documents.

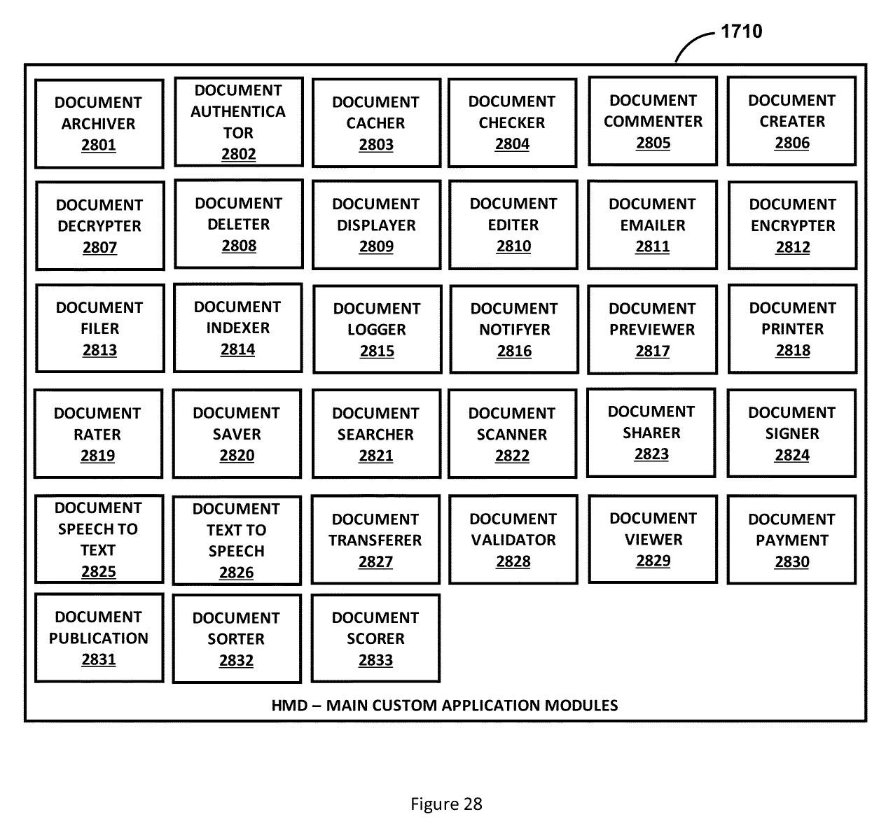

FIG. 28 illustrates custom application modules or components that may be created for HMD 1710 including a digital agreement manager extending components and features inherent in HMDs. The digital agreement manager directly or indirectly facilitates additional functionality for HMD users to annul, approve, archive, cancel, collaborate, create, delete, digitally sign, edit, email, encrypt, listen to, notarize, preview, read, reject, retrieve, save, scan, search, and share digital agreements, contracts, deeds and other electronic documents. Examples of how the custom application modules may be leveraged by the HMD user in the present invention are described below. A document archiver 2801 for document storing on disk locally on the HMD or in the Cloud. A document authenticator 2802 for authorizing access to via security software features and digital signature verification. A document cacher 2803 for document storing in RAM locally on the HMD and in RAM on Cloud Servers for quick access. A document checker 2804 for document integrity and validation checking A document commenter 2805 for document notes and remarks. A document creator 2806 for document establishing new agreements and related documents. A document decrypter 2807 for document decoding. A document deleter 2808 for document removal. A document displayer 2809 for document displaying. A document editor 2810 for document updating. A document emailer 2811 for document collaboration and sharing. A document encrypter 2812 for document encoding. A document filer 2813 for document organization and storage. A document indexer 2814 for document categorization and faster access. A document logger 2815 for document audit trails and debugging. A document notifier 2816 for document alerts and email messages. A document previewer 2817 for document displaying and reviewing. A document printer 2818 for document hard copies and physical reproduction. A document rater 2819 for document scoring. A document saver 2820 for document archival on disk locally on the HMD or in the Cloud. A document searcher 2821 for document searching and document content indexing and searching. A document scanner 2822 for document uploading and storage locally on the HMD or in the Cloud. A document sharer 2823 for document collaboration and emailing. A document signer 2824 for document autographing, digital signatures, agreement and authentication. In the event the digital agreement document requires notarization, a notarization will be possible by adding a digital signature of a notary public thereby notarizing the formal digital agreement. A document speech to text 2825 for user reading of a document so the HMD may record or transcribe it to text and save it locally on the HMD or in the Cloud. A document text to speech 2826 for HMD reading of a document for the user. A document transferer 2827 for document archiving, collaboration, emailing and storage in the Cloud. A document validator 2828 for document integrity checking A document viewer 2829 for document display and previewing. A document payment 2830 for document billing and fees. A document publication 2831 for private document publication in the Cloud or public document publication in a catalog for one or more parties. A document sorter 2832 for document categorization. A document scorer 2833 for customer evaluation of a document. A digital agreement content customizer may include one or more of the following to enhance the digital agreement storefront experience for the HMD user; indexed digital agreement content 2814, searchable digital agreement content 2821, rated digital agreement content 2819, scored digital agreement content 2833, and sorted digital agreement content 2832.

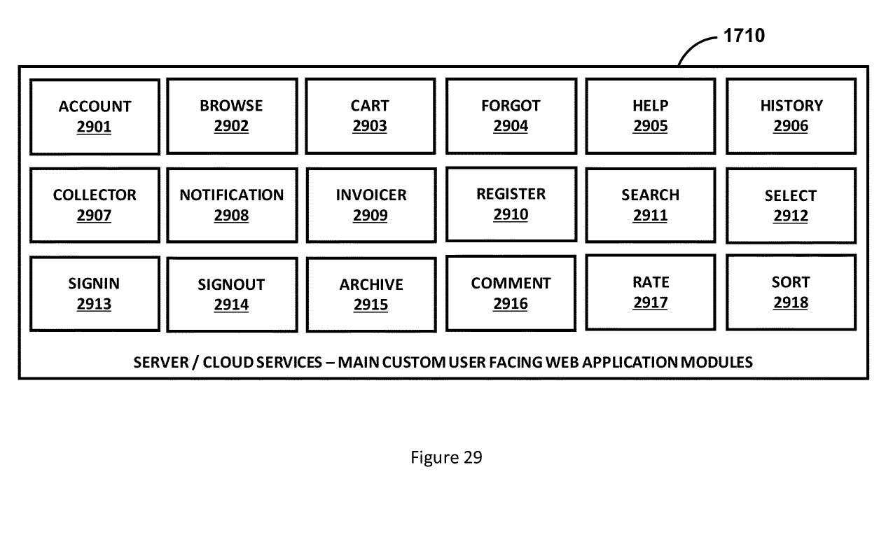

FIG. 29 illustrates the main custom user facing web application modules or components that may be created for HMD 1710 connected to the web using an Intranet or the Internet providing additional methods for users to browse, sort, rate, purchase, and archive electronic documents including agreements and agreements templates hosted via cloud services. Examples of how the custom user facing web application modules may be leveraged by the HMD in the present invention are described below. An account module 2901 for a web based globally accessible user authentication component via HMDs and cloud services. A browsing module 2902 for a web based globally accessible caching, organization and listing component for electronic documents via HMDs and cloud services. A digital agreement shopping cart module 2903 for a web based globally accessible list of electronic documents including digital agreements for purchasing via HMD devices by HMD users over networks and cloud services. The digital agreement shopping cart may be configured to maintain an inventory of user selected formal digital agreements for the HMD user. A forgot password module 2904 for a web based globally accessible password and for user id recovery component via HMDs and cloud services. A help module 2905 for a web based globally accessible user support component via HMDs and cloud services. A history module 2906 for a web based globally accessible transaction tracking and display component via HMDs and cloud services. A digital agreement collector module 2907 for a web based globally accessible billing and purchasing collection component, which is configured to receive payment for the HMD user selected formal digital agreements. A notification module 2908 for a web based globally accessible alerting and emailing component via HMDs and cloud services. A digital agreement invoicer module 2909 for a web based globally accessible HMD user invoice, which is configured to provide an invoice for user selected formal digital agreements for the HMD user. A registration module 2910 for a web based globally accessible user authentication, recording, and registration component via HMDs and cloud services. A searching module 2911 for a web based globally accessible electronic document finding component via HMDs and cloud services. A selection module 2912 for a web based globally accessible electronic document review and download component via HMDs and cloud services. A sign in module 2913 for a secure web based globally accessible user authentication and log in component via HMDs and cloud services. A sing out module 2914 for a web based globally accessible user log out component via HMDs and cloud services. An archiving module 2915 for a web based globally accessible repository of electronic documents via HMDs and cloud services. A commenting module 2916 for a web based globally accessible note and remarking component for electronic documents via HMDs and cloud services. A rating module 2917 for a web based globally accessible scoring component for electronic documents via HMDs and cloud services. A sorting module 2918 for a web based globally accessible cataloging and organization component of electronic documents via HMDs and cloud services.

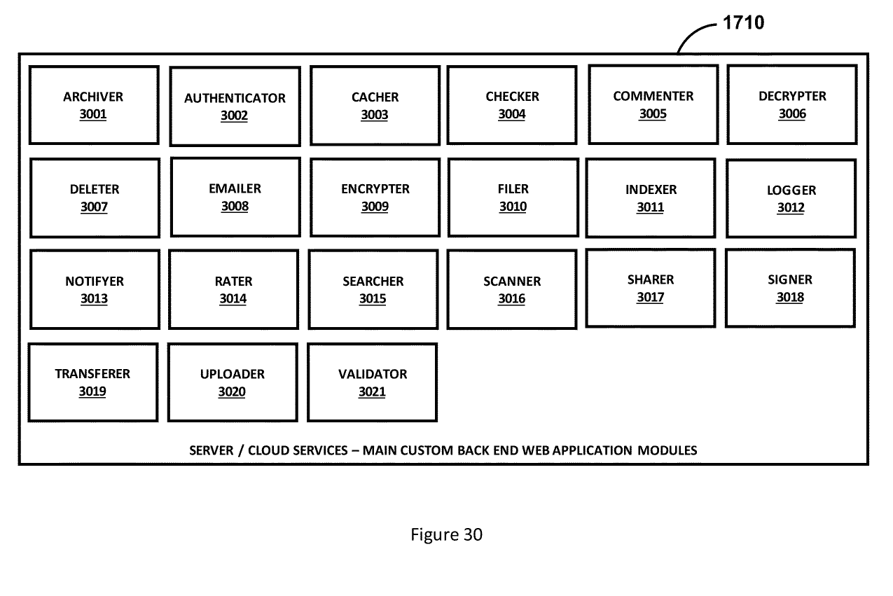

FIG. 30 illustrates the main custom back end web application modules or components that are hosted via cloud services providing methods for the HMD user and the aforementioned custom user facing web modules in the present invention. The cloud based servers and services provide a richer document management and digital agreement collaboration experience for HMD users and the custom user facing web based services. Authorized and network connected HMD users may take advantage of these highly available, rich and scalable services providing application processing, caching, cataloging, collaboration, data processing, data storing, security, and authorization. It is assumed the HMD users have network connectivity such as Bluetooth, LANs, Radio, Satellite, WANs, and WIFI connections. Network connectivity is important in order to ensure access to a digital agreement depository configured to archive HMD user selected formal digital agreements for the HMD user. The depository consists of digital agreements selected by the HMD user for storage, future reference, and easy access. Further details are described below. An archiver module 3001 for cloud accessible document storage and retrieval. An authentication module 3002 for cloud accessible HMD user verification. A cacher module 3003 for cloud accessible cached and popular transactions. A checker module 3004 for cloud accessible document validation. A commenter module 3005 for cloud accessible note and remarking. A decrypter module 3006 for cloud accessible document and transaction decoding. A deleter module 3007 for cloud accessible electronic document trash cans and electronic document undelete functions. An emailer module 3008 for cloud accessible collaboration and sharing. An encrypter module 3009 for cloud accessible document and transaction encoding. A filer module 3010 for cloud accessible organization, storage, and retrieval. An indexer module 3011 for cloud accessible electronic document and document content cataloging. A logger module 3012 for cloud accessible audit trails. A notifyer module 3013 for cloud accessible alerts, emails, sms, and text messages. A rater module 3014 for cloud accessible scoring of electronic documents. A searcher module 3015 for cloud accessible document arrangement, fetching and content retrieval. A scanner module 3016 for cloud accessible document uploading methods. A sharer module 3017 for cloud accessible collaboration and document distribution. A signer module 3018 for cloud accessible signature authentication and certificate verification methods. A transferer module 3019 for cloud accessible electronic document sharing and storage. An uploader module 3020 for cloud accessible publishing of electronic documents. A validator module 3021 for cloud accessible integrity checking and verification of electronic documents.

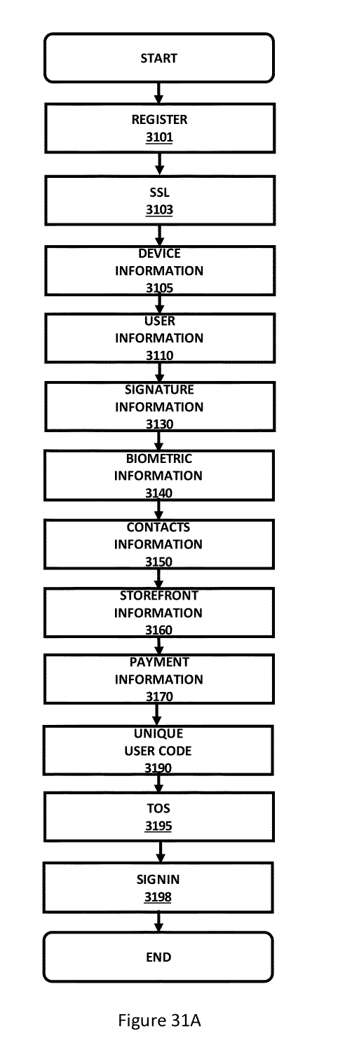

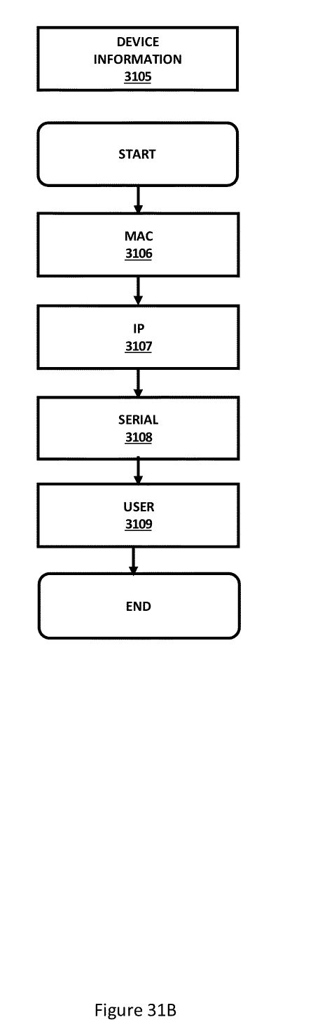

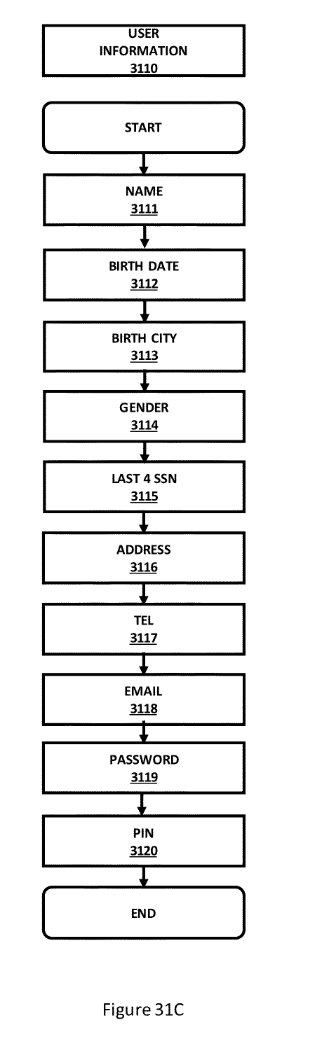

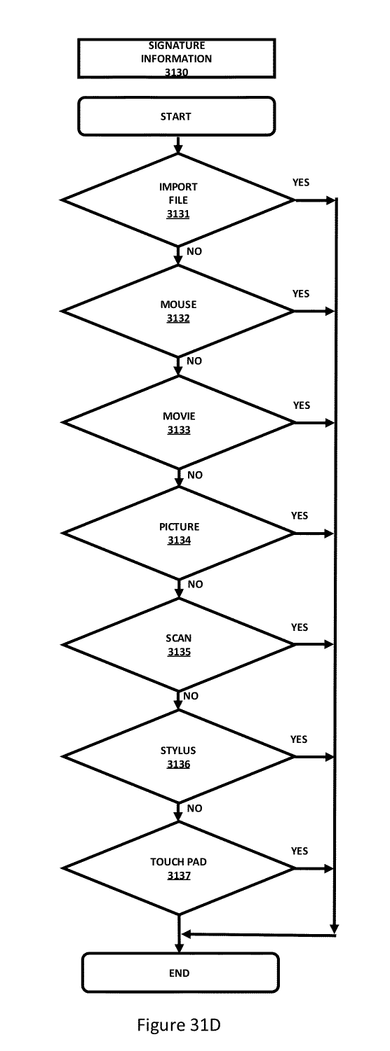

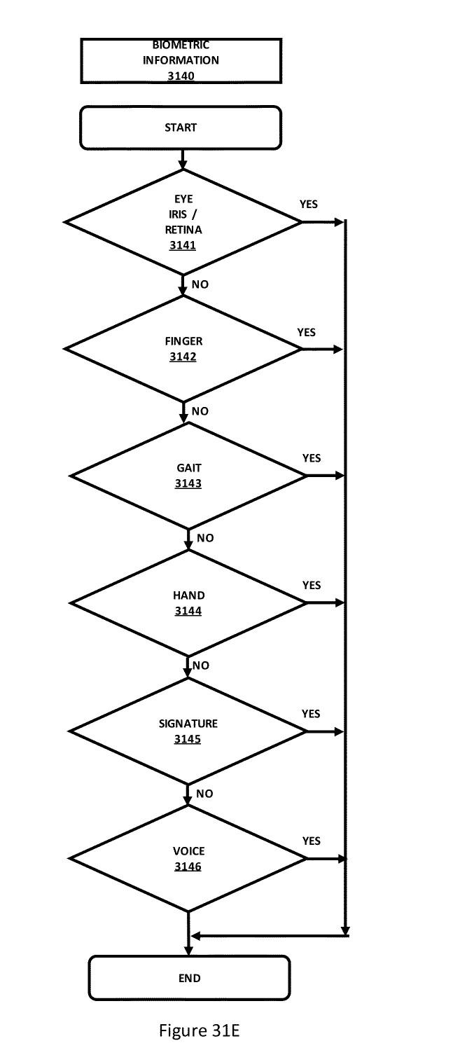

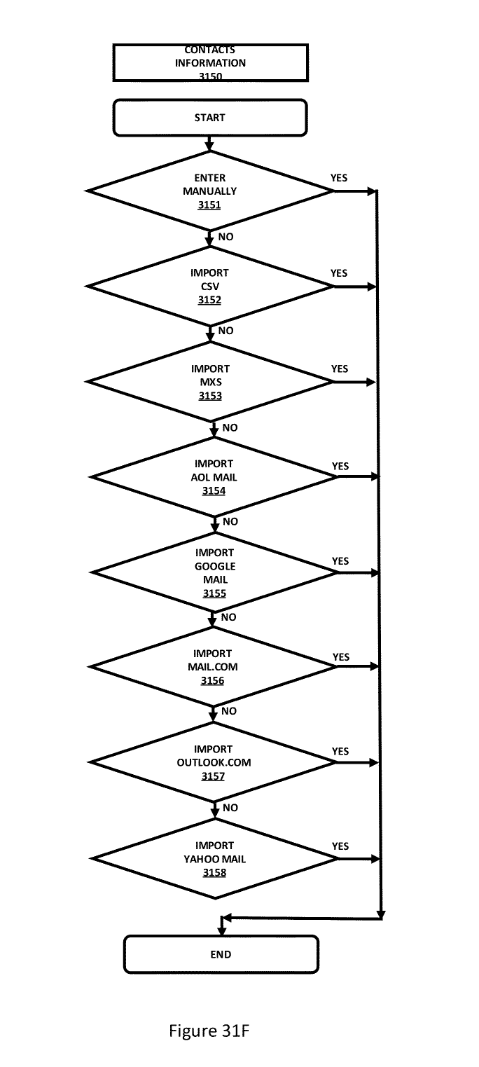

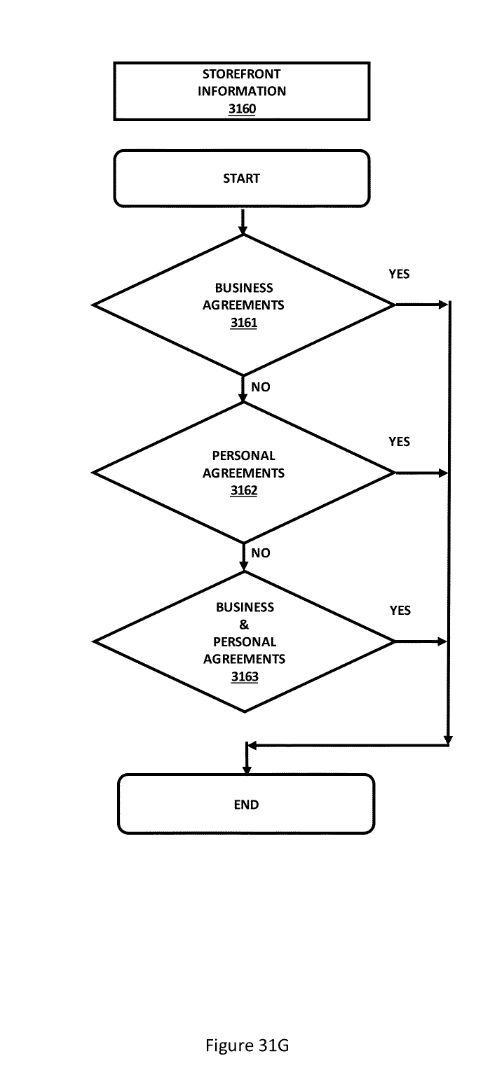

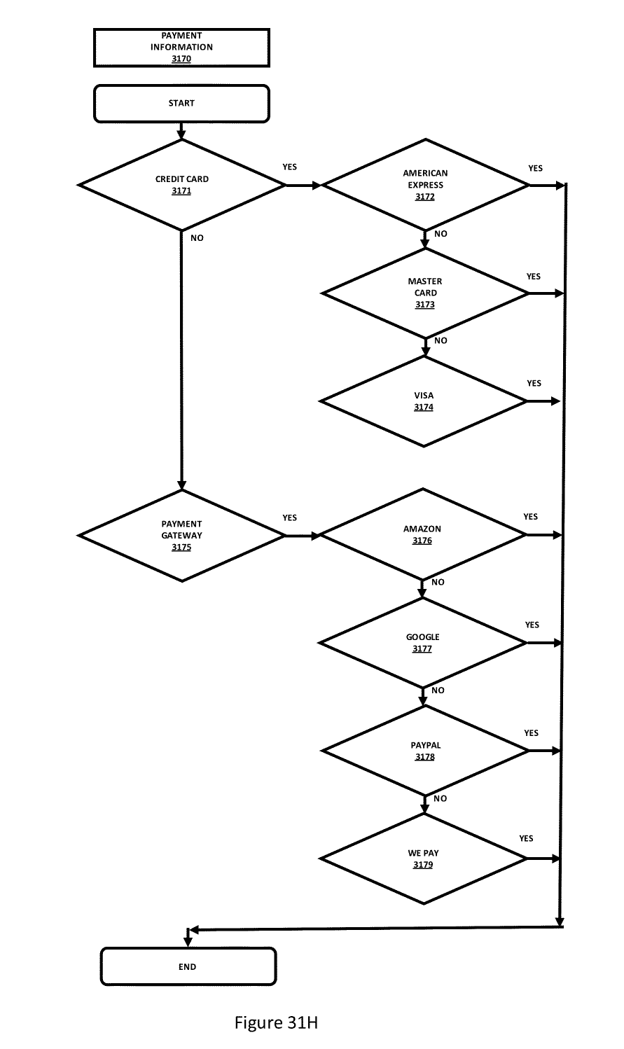

FIGS. 31A-H illustrate flowchart diagrams depicting features, functions, and methods for HMD users to register (stage 3101) to use a digital agreement establishment and signing system that offers the ability to view, edit, sign, and manage agreements, contracts, deeds and other electronic documents. The system requires the HMD device to have a working network connection as described in other parts of the present invention. Communication to and from the network including Cloud Services will be via secure methods such as Secure Socket Layer (SSL) (stage 3103). To validate a HMD device via authentication data, validate the HMD users personal information, authentication data and ratification methods of a person's identity may verified using the help of a 3rd party for fraud mitigation and fraud detection. If necessary, black lists may be referenced including lists of HMD users in undesirable locations, with undesirable addresses, with undesirable email addresses, and with undesirable names.

Once the HMD device connects to network including Cloud Services registration systems, device authenticating information (stage 3105) is gathered such as machine address code or media access control (MAC) address (stage 3106), internet protocol (IP) address (stage 3107), device serial number (stage 3108), device username (stage 3109) and other information.

The next step of the registration process requires the HMD user to provide personal and selfidentifying user information (stage 3110). For example, name (stage 3111), birth date (stage 3112), birth city (stage 3113), gender (stage 3114), last 4 social security number (SSN) (stage 3115), street address (stage 3116), telephone number (stage 3117), email address (stage 3118), password (stage 3119) and pin code (stage 3120).

The next step of the registration process requires the HMD user to provide personal and selfidentifying signature information (stage 3130). Example methods for providing signature information include:
Import File (stage 3131): Import a signature file. Example file formats include BMP, GIF, JPG, PDF, and PNG.
Mouse (stage 3132): Use a mouse connected to the HMD or another device to create a signature file for importing.
Movie (stage 3133): Use a hand or finger drawing the signature in front of the HMD camera or other device camera creating a movie or series of pictures generating a pattern and signature outline used to create a signature file for importing.
Picture (stage 3134): Write the signature on a piece of paper or other surface and take a picture using the HMD camera or other device camera creating an autograph file or signature file for importing.
Scan (stage 3135): Scan an existing signature via the HMD scanner or other device scanner creating a signature file for importing.
Stylus (stage 3136): Use a stylus connected to the HMD or another device to create a signature file for importing.
Touch Pad (stage 3137): Use the touch pad on the HMD, a touchpad connected to the HMD or another device to create a signature file for importing.

The next step of the registration process requires the HMD user to provide personal and selfidentifying biometric information (stage 3140). For example, eye/iris/retina scan (stage 3141), finger print or scan (stage 3142), gait (aka stride or walking motion) (stage 3143), hand geometry, palm print or scan (stage 3144), signature (using a pen to sign on paper or a finger to sign in the air) (stage 3145), or voice recognition including a voice print by analyzing patterns in a person's spoken name, a command, a phrase, a sentence, or words (stage 3146). The next step of the registration process requires the HMD user to provide contacts information (stage 3150). The contacts may be useful when addressing agreements or documents to a person and for adding contact email addresses. The contact information may be entered manually (stage 3151), imported via a CSV file (stage 3152), imported via Microsoft Exchange Server (MXS) (stage 3153), imported via AOL mail (stage 3154), imported via Google mail (stage 3155), imported via mail.com (stage 3156), imported via outlook.com (stage 3157), and imported via Yahoo mail (stage 3158).

The next step of the registration process requires the HMD user to provide storefront information (stage 3160) and viewing preferences. Example storefront catalogs which HMD uses may view and work with include business agreements (stage 3161), personal agreements (stage 3162), and both business and personal agreements (stage 3163). The next step of the registration process is optional, but if selected, requires the HMD user to provide billing and payment information (stage 3170). For example, credit card (stage 3171) information includes options such as American Express (stage 3172), Master Card (stage 3173) or Visa (stage 3174). Otherwise, payment gateway 3175 information includes options such as Amazon (stage 3176), Google (stage 3177), PayPal (stage 3178), or We Pay (stage 3179). The next step of the registration process requires the HMD user to provide a unique user code 3190 identifying they are a legitimate live person.

The final step of the registration process requires the HMD user to review and acknowledge the Terms of Service (TOS) (stage 3195) for conditions and terms about services provided and system usage. Once the registration has been successfully completed, the HMD user may sign in (stage 3198).

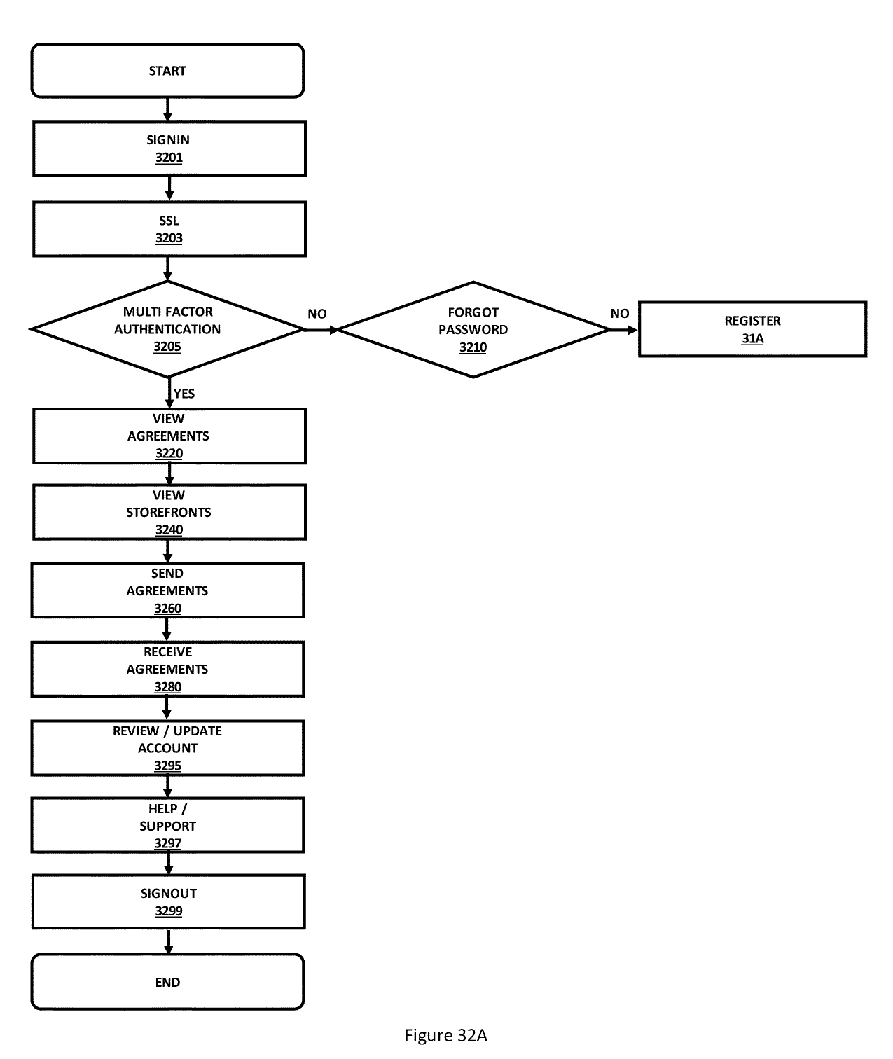

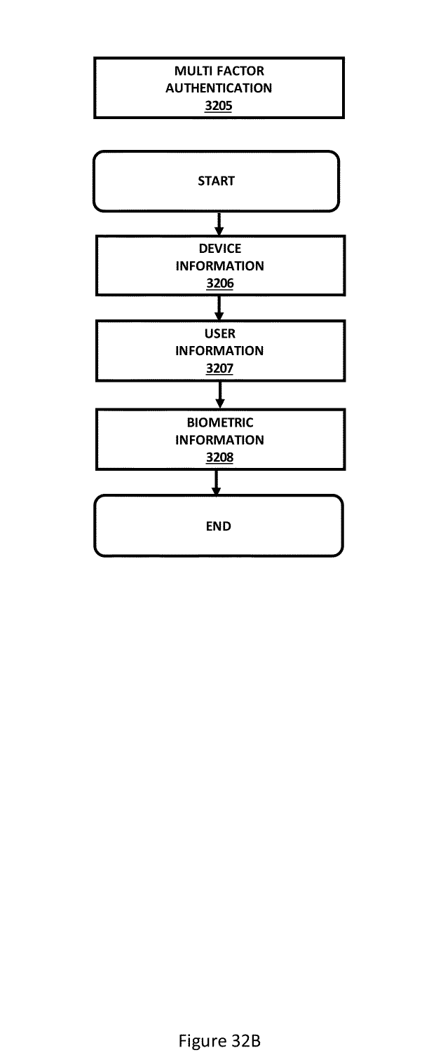

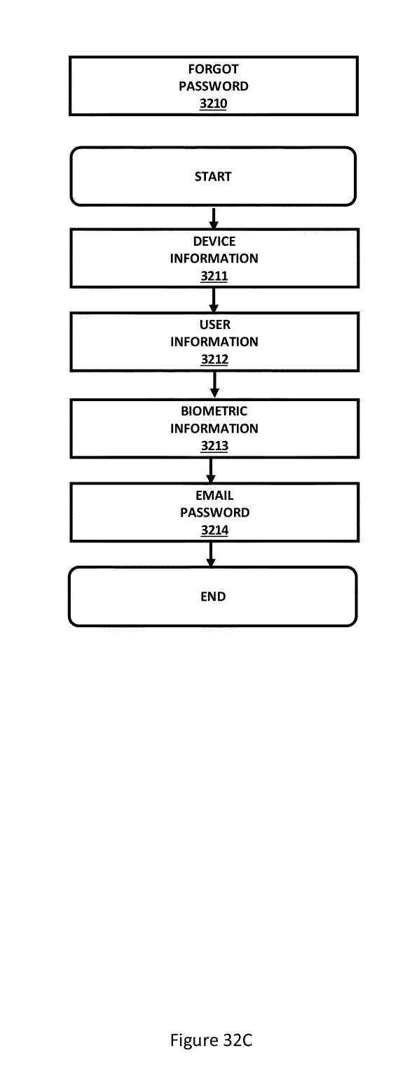

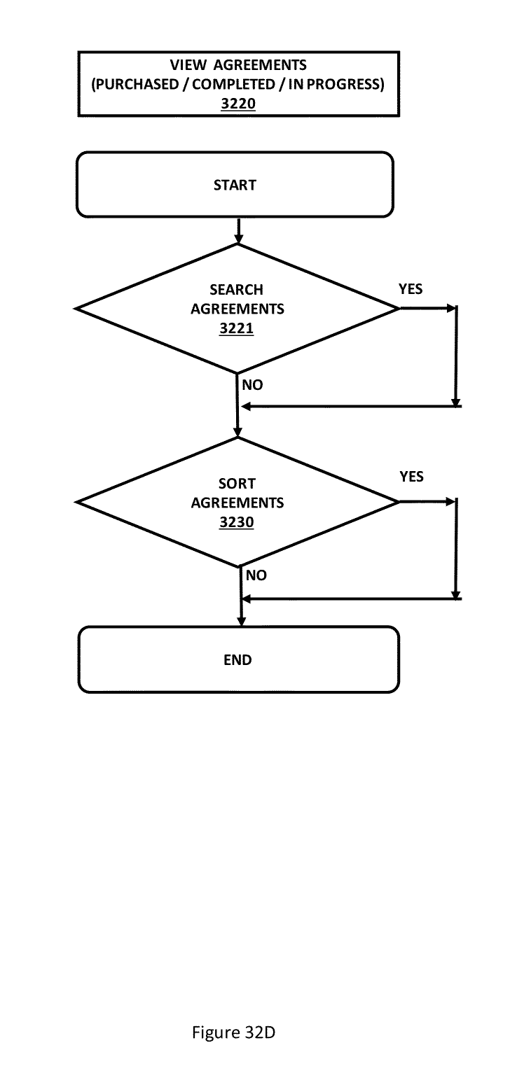

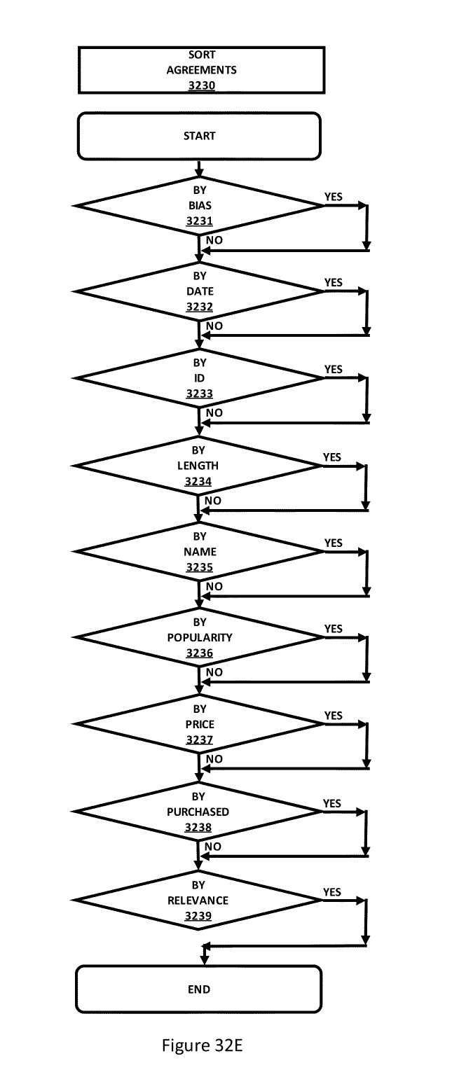

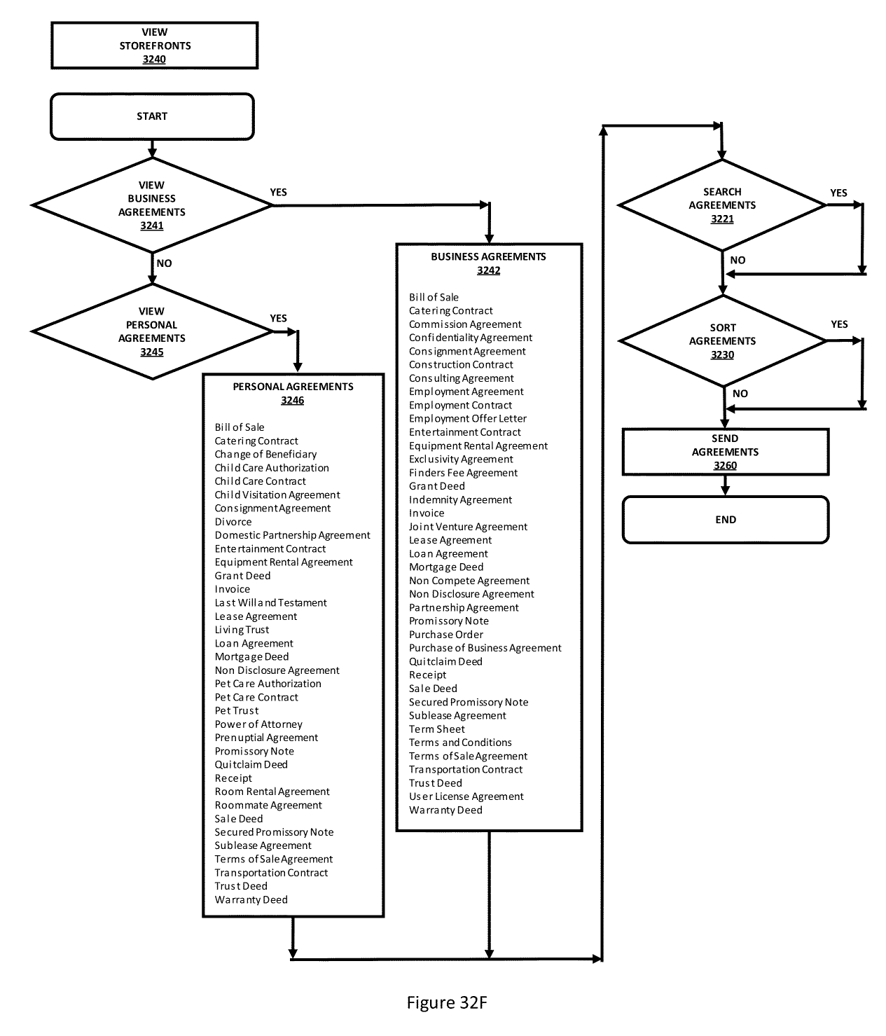

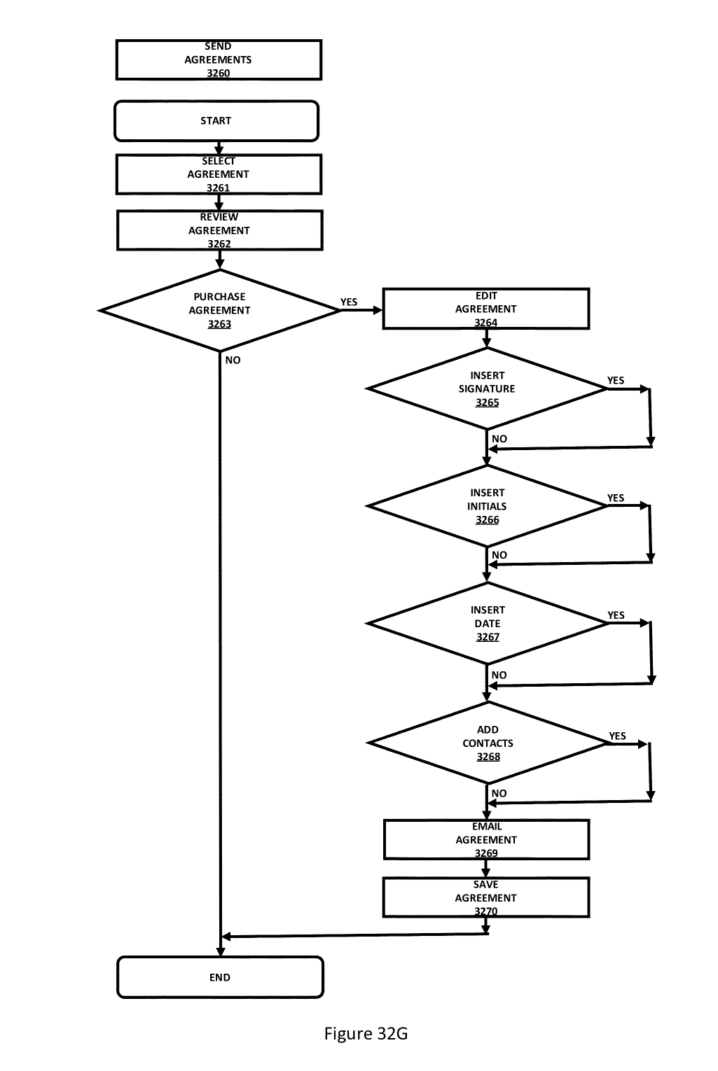

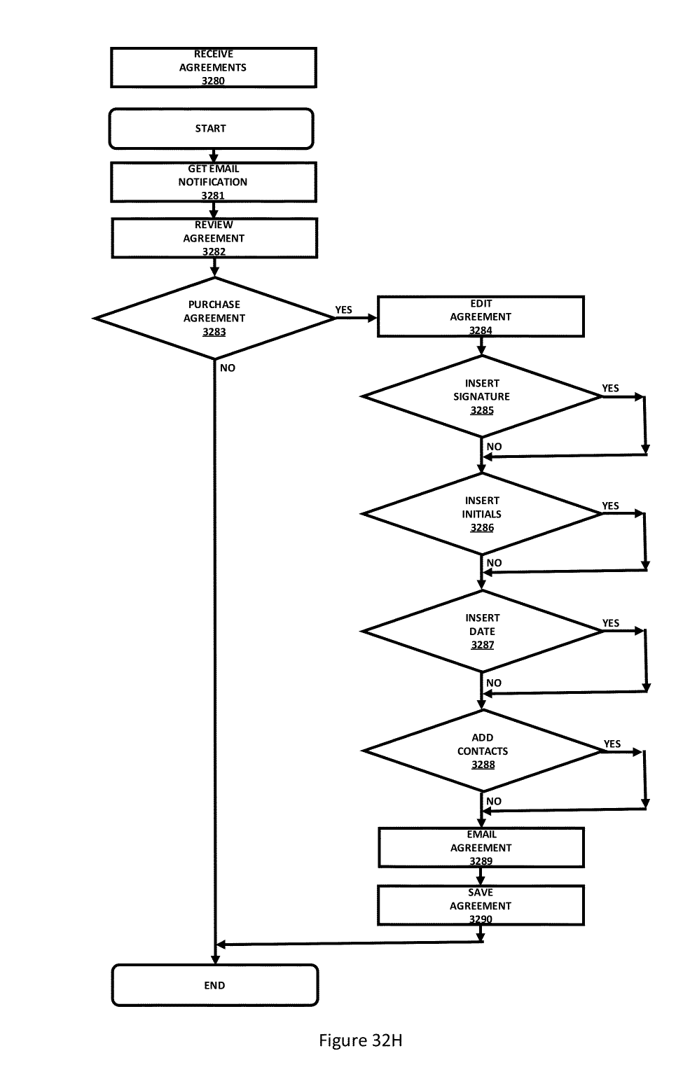

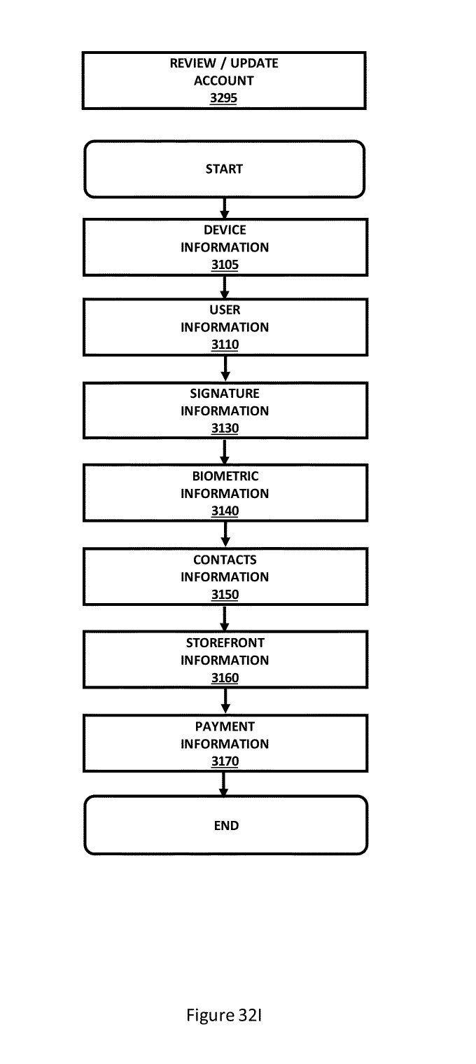

FIGS. 32A-I illustrate flowchart diagrams depicting a computerized system with features, functions, and methods for HMD users who are registered users of this system to sign in (stage 3201), and use the a digital agreement establishment and signing system that offers the ability to view, edit, sign, and manage agreements, contracts, deeds and other electronic documents. The system requires the HMD to have a working network connection as described earlier in the present invention. Furthermore, it is assumed the necessary Cloud Services are hosted via an Intranet or the Internet as described earlier in the present invention and the HMD can access the necessary Cloud Services.

Communication to and from the Cloud Services is via secure methods such as Secure Socket Layer (SSL) (stage 3203).

Once the HMD device connects to the network including the back-end network and Cloud Services systems, an authenticator is used to provide multi-factor authentication (stage 3205) methods to identify the HMD device and user. Examples include device information (stage 3206), user information (stage 3207), and biometric information (stage 3208). Example user biometric information where one or more information points may be used in the multi-factor authentication data scheme include voice, touch pad, eye, head, hand, finger, and other biometric authentication means documented in the present invention.

If the authentication is unsuccessful, a forgot password flow (stage 3210) is offered. Options for recreating a password may be based on multiple sources including device information (stage 3211), user information (stage 3212), biometric information (stage 3213), and email password (stage 3214).

If the HMD user is still unable to access the system, they are sent to the new HMD user registration process 31.

Once authenticated and signed in, the HMD user may access a user interface to view the digital storefront and digital agreements (stage 3220) that are completed, in progress and have been purchased. Options include:
Browse digital agreements and select an agreement.
Search digital agreements (stage 3221) and digital agreements templates by using a name or keywords.
Sort digital agreements (stage 3230) and digital agreements templates.
By Date (stage 3232): Digital Agreement Creation date or entry date into the digital storefront.
By Bias or Fairness (stage 3231): Fairness of the digital agreement as it is written for the Party A vs. Party B.
By ID (stage 3233): Digital Agreement identification code or tag.
By Length (stage 3234): Digital Agreement length in terms of file size, number of pages or words.
By Name (stage 3235): Digital Agreement unique identifying name.
By Popularity (stage 3236): Digital Agreement rating by users. Examples include NPS rating, star ratings, percentage recommended ratings, or by number of purchases.
By Price (stage 3237): Digital Agreement or agreement template purchase price for the HMD user.
By Purchased (stage 3238): Show all previously and recently purchased digital agreements and digital agreements templates.
By Relevance (stage 3239): Show digital agreement and digital agreement template names based on the search string used as the name or keywords.
Select digital agreement or digital agreements template.
Review the selected digital agreement details.
Purchase the digital agreement or digital agreement template using a credit card or payment gateway.
Receive an Email Receipt of the purchase.
Edit the digital agreement by populating fields as necessary. For example, add signatures, initials and dates.
Archive or Save the digital agreement locally and on a network including storage hosted via Cloud Services or Web Services.
Email the digital agreement to oneself, one or more parties for review, signature, initials, date, other required input, and a response.

Once authenticated and signed in, the HMD user may access a user interface to view digital storefronts (stage 3240). They may be interested in browsing, reviewing, and purchasing agreements and agreements templates.

In addition, one of the system components includes providing the registered and signed-in HMD user auto-selection of digital agreements based on what they are looking for, the HMD users own preferences, who they are targeting and result provided with artificial intelligence to with recommendations considering a likelihood to agree or accept factor that both sides will find the digital agreement acceptable.

Example digital storefronts include, but are not limited to:

Viewing Business Agreements (stage 3241 and stage 3242): Contracts, Deeds, Employment Agreements and Nondisclosure agreements.

Viewing Personal Agreements (stage 3245 and stage 3246): Contracts, Childcare agreements, Deeds, Domestic Partnerships and Non-disclosure agreements.

Both Business and Personal Agreements: Agreements, bills of sale, bonds, certificates, contracts, covenants, deals, deeds, licenses, notices, pacts, passes, permits, terms, and tickets.

Examples methods how the HMD user may use the digital storefront includes:
Browse digital agreements and select a digital agreement.
Search digital agreements (stage 3221) and digital agreements templates by using a name or keyword.
Sort agreements (stage 3230) and agreements templates.
By Date: Agreement Creation date or entry date into the storefront.
By Fairness: Fairness of the agreement as it is written for the Party A vs. Party B.
By ID: Agreement identification code or tag.
By Length: Agreement length in terms of file size, number of pages or words.
By Name: Agreement unique identifying name.
By Popularity: Agreement rating by users. Examples include NPS rating, 1 to 5 star ratings, percentage recommended ratings, or by number of purchases.
By Price: Agreement or agreement template purchase price for the HMD user.
By Purchased: Show all previously and recently purchased digital agreements and digital agreements templates.
By Relevance: Show digital agreement and digital agreements template names based on the search string used as the name or keywords.

The following list represents some examples of business agreements (stage 3242) that may be purchased in the storefront, edited, signed, shared, and established in accordance with the present invention:
Bill of Sale
Catering Contract
Commission Agreement
Confidentiality Agreement
Consignment Agreement
Construction Contract
Consulting Agreement
Employment Agreement
Employment Contract
Employment Offer Letter
Entertainment Contract
Equipment Rental Agreement
Exclusivity Agreement
Finders Fee Agreement
Grant Deed Indemnity
Invoice
Joint Venture
Lease Agreement
Loan Agreement
Mortgage Deed
Non Compete Agreement
Non Disclosure Agreement
Partnership Agreement
Promissory Note
Purchase Order
Purchase of Business
Quitclaim Deed
Receipt
Sale Deed
Secured Promissory Note
Sublease Agreement
Term Sheet
Terms and Conditions
Transportation Contract
Trust Deed
User License Agreement
Warranty Deed

The following list represents some examples of personal agreements (stage 3246) that may be purchased in the storefront, edited, signed, shared and established in accordance with the present invention:
Bill of Sale
Catering Contract
Change of Beneficiary
Child Care Authorization
Child Care Contract
Child Visitation
Consignment Agreement
Divorce
Domestic Partnership
Entertainment Contract
Equipment Rental Agreement
Grant Deed
Invoice
Last Will and Testament
Lease Agreement
Living Trust
Loan Agreement
Mortgage Deed
Non Disclosure Agreement
Pet Care Authorization
Pet Care Contract
Pet Trust
Power of Attorney
Prenuptial
Promissory Note
Quitclaim Deed
Receipt
Revocation of Power of Attorney
Room Rental Agreement
Roommate Agreement
Sale Deed
Secured Promissory Note
Sublease Agreement
Transportation Contract
Trust Deed
Warranty Deed

Once the HMD user is authenticated and signed into the system, the HMD user may establish new digital agreements and send digital agreements (stage 3260) by the following steps:
Browse digital agreements and select a digital agreement (stage 3261).
Review the selected digital agreement (stage 3262) details.
Purchase the selected digital agreement (stage 3263).
   Purchasing of the digital agreement may happen at this point of the process if the HMD user is certain they want this agreement, or at a later point.
   The later point may be preferable by the HMD user upon signing, saving and sending the digital agreement to another HMD user. This method offers the HMD user a pay per HMD user sent to model verses a possibly higher flat rate payment option for unlimited use of a particular digital agreement or digital agreement template.
Edit the digital agreement (stage 3264) by populating fields as necessary. For example, insert signature (stage 3265) or autograph, insert initials (stage 3266) and insert date (stage 3267). For further details on obtaining, comparing and digitally signing, see the other sections of the present invention about signing.
Add contacts (stage 3268). For further details on adding and importing contacts, see the other sections of the present invention about contacts.
Email the digital agreement (stage 3269) to one or more parties for review, signature, and a response.
Archive or Save the digital agreement (stage 3270) locally and via the network including Cloud Services.
Once the digital agreement is signed and returned via email by the other party or parties it was sent to, a notification is received by the HMD user. Notification examples include an email, text message, message or ticker tape on the display of the HMD device.
If an digital agreement is received to be established, the HMD user may help establish the digital agreement by the following steps:
Look for email notification to establish new digital agreements.
Review the selected digital agreement details.
Edit the digital agreement by populating fields as necessary. For example, add signatures or autographs, initials and dates. For further details, see the example methods for providing signature information in the detailed description for FIG. 28.
Archive or Save the digital agreement locally and via the network including Cloud Services.
Email the digital agreement to one or more parties for review, signature, and a response.
Once authenticated and signed in, the HMD user may receive digital agreements (stage 3280) by the following steps:
Get email notification (stage 3281) about a digital agreement sent by one or more parties.
Review the digital agreement (stage 3282).
Purchase the digital agreement (stage 3283).
Edit the digital agreement (stage 3284) by populating fields as necessary. For example, insert signature (stage 3285) or autograph, initials (stage 3286) and insert date (stage 3287). For further details on obtaining, comparing and digitally signing, see the other sections of the present invention on signing.
Add contacts (stage 3288). For further details on adding and importing contacts, see the other sections of the present invention on contacts.
Email the digital agreement (stage 3289) to oneself, or one or more parties.
Archive or Save the digital agreement (stage 3290) locally and on the network including Cloud Services.
Other options provided for registered and signed in HMD users includes features and functions to review and update account information (stage 3295) including:
Device information (stage 3105): For further details on obtaining, comparing and digitally signing, see the other sections of the present invention on device information.
User information (stage 3110): For further details on obtaining, comparing and digitally signing, see the other sections of the present invention on user information.
Signature information (stage 3130): For further details on obtaining, comparing and digitally signing, see the other sections of the present invention on signature information.
Biometric information (stage 3140): For further details on obtaining, comparing and digitally signing, see the other sections of the present invention on biometric information.
Contacts information (stage 3150): For further details on obtaining, comparing and digitally signing, see the other sections of the present invention on contacts information.
Storefront information (stage 3160): For further details on obtaining, comparing and digitally signing, see the other sections of the present invention on storefront information.
Payment information (stage 3170): For further details on obtaining, comparing and digitally signing, see the other sections of the present invention on payment information.

Other options provided for registered and signed in HMD users includes the ability to get online help and support information (stage 3297). Examples which are provided via the HMD device to the HMD user include frequently asked questions (FAQs), quick start guides, full documentation, and video tutorials.

Other options provided for signed in HMD users is to sign out (stage 3299).

Many modifications and additions to the described embodiments are contemplated within the scope of the present invention. For example, the exemplary agreements described above can range from adhesion documents with non-modifiable clauses; to semi-customizable documents with the option of selecting from a variety of alternate clauses; to fully-customizable documents with the option of modifying the language of the selected clauses, and combinations thereof. It is also possible for the system to provide additional services such as real-time audits within and/or amongst documents for consistency and regulatory compliance, reminders for renewals/terminations. Further, the above methods can also be implemented on other wearable computing devices, such as wrist-worn devices, hand-worn devices and other head-gear devices.

While various aspects and embodiments have been disclosed in the present invention, other aspects and embodiments will be apparent to those skilled in the art. The various aspects and embodiments disclosed herein are for purposes of illustration and are not intended to be limiting. The true scope and spirit are indicated by the following claims, along with the full scope of equivalents to which such claims are entitled. Furthermore, the terminology used herein is for the purpose of describing particular embodiments only and is not intended to be limiting in any way.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for managing formal digital agreements of registered head mounted display (HMD) users, the method comprising:
receiving HMD authentication data associated with a HMD;
receiving user authentication data associated with a HMD user of the HMD;
receiving a user digital signature associated with the HMD user; and
using the HMD authentication data, the user authentication data, and the user digital signature to access a formal digital agreement.

2. The method of claim 1, further comprising accepting a digital signature from the HMD user intended to at least one of agree, approve, authorize, certify, consent, declare, endorse, sanction, and testify the selected formal digital agreement.

3. The method of claim 1, wherein the user authentication data includes biometric authentication data, wherein the biometric authentication is at least one of an eye scan, a finger print, a gait, a hand geometry, a iris scan, a palm print, a retina scan, a signature, and a voice print.

4. The method of claim 1, wherein the voice print is vocalized by the HMD user, and recorded by the HMD, and wherein the voice print includes at least one of a command, a name, a phrase, a sentence, and a word.

5. The method of claim 2, wherein the signature is at least one of an imported signature file, a scanned signature, and an autographed signature recorded via at least one of a camera, a display, and a touch pad of the HMD.

6. The method of claim 1, wherein the eye scan, the iris scan, and the retina scan are recorded via at least one of a camera, and a scanner of the HMD.

7. The method of claim 1, wherein the finger print, the hand geometry, and the palm print are recorded via at least one of a camera, and a scanner of the HMD.

8. The method of claim 2, wherein the user digital signature is received using a virtual pen and a virtual sketchpad, wherein the virtual pen is an instantiation of at least one of a physical arm, a hand, a finger, a finger nail, a finger pinch, a finger ring, a finger sign, a stylus, and a writing utensil, and wherein the virtual sketchpad is an instantiation of at least one of a drawing surface, a sketch pad, a touch pad, a writing surface, and a contrasting background.

9. The method of claim 2, wherein the user digital signature belongs to the HMD user and is at least one of an inscription, an insignia, an initial, a check mark, a signature, a symbol, an alphabet character, a numeric character, a punctuation character, an accented character, and a pictographic character.

10. The method of claim 1, wherein the formal digital agreement is at least one of a bill of sale, a bond, a certificate, a contract, a covenant, a deal, a deed, a license, a notice, a pact, a pass, a permit, a term, a ticket, and a will, and wherein the formal digital agreement is intended for the creation of agreements for the benefit of at least one or more parties.

11. A computerized system configured to enable registered head mounted display (HMD) users, the method comprising:
an HMD user authenticator configured to receive HMD authentication data associated with a HMD, and to receive user authentication data associated with a HMD user of the HMD;
a digital agreement storefront having a user interface configured to provide access to a plurality of formal digital agreements for the HMD user via a network;
a digital agreement shopping cart configured to maintain an inventory of user selected formal digital agreements for the HMD user;
a digital agreement invoicer configured to provide an invoice for user selected formal digital agreements for the HMD user; and
a digital agreement collector configured to receive payment for the HMD user selected formal digital agreements.

12. The system of claim 11, further comprising a digital agreement content customizer configured to provide at least one of indexed digital agreement content, searchable digital agreement content, rated digital agreement content, scored digital agreement content, and sorted digital agreement content.

13. The system of claim 11, further comprising a digital agreement depository configured to archive HMD user selected formal digital agreements for the HMD user.

14. The system of claim 11, further comprising a digital agreement manager configured to provide at least one of annulment, approval, archival, cancellation, collaboration, creation, deletion, digitally signing, editing, emailing, encrypting, listening to, notarizing, previewing, reading, rejecting, retrieval, saving, scanning, searching, and sharing of the formal digital agreement for the HMD user.

15. The system of claim 14, wherein the previewing of the formal digital agreement includes displaying at least one of an essence, a spirit, and a summary of the formal digital agreement.

16. The system of claim 14, wherein the notarizing of the formal digital agreement includes recognizing a digital signature of a notary public thereby notarizing the formal digital agreement.

17. A computerized method for manipulating a formal digital agreement via head mounted display (HMD) devices by HMD users, the method comprising: processing a physiological user input intended to manage a formal digital agreement management; and providing a corresponding manipulation of the formal digital agreement in response to the physiological user input.

18. The method of claim 17, wherein the physiological user input is a vocalized sound.

19. The method of claim 17, wherein the physiological user input is at least one of a limbic movement, a head movement, an eye movement, and an eye lash movement.

20. The method of claim 19, wherein the physiological user input is determined by at least one of a button, a camera, a gyroscope, a motion sensor, a scanner, and a touch pad mounted on the HMD.
